(19) United States
(12) Patent Application Publication
(10) Pub. No.: US 2015/0096238 A1
(43) Pub. Date: Apr. 9, 2015

(54) ABRASIVE PARTICLES, SLURRY, POLISHING SOLUTION, AND MANUFACTURING METHODS THEREFOR

(71) Applicant: HITACHI CHEMICAL COMPANY, LTD., Tokyo (JP)

(72) Inventor: Tomohiro Iwano, Hitachi-shi (JP)

(21) Appl. No.: 14/401,216

(22) PCT Filed: Mar. 26, 2013
(86) PCT No.: PCT/JP2013/058769

§ 371 Date: Nov. 14, 2014

(30) Foreign Application Priority Data
May 22, 2012 (JP) 2012-116868

(51) Int. Cl. C09K 3/14; C09G 1/02

(52) U.S. Cl. CPC C09K 3/1409; C09K 3/1463; C09G 1/02
USPC 51/307

(57) ABSTRACT

A method for manufacturing an abrasive grain, comprising a step of obtaining a particle including a hydroxide of a tetravalent metal element by mixing a metal salt solution comprising a salt of the tetravalent metal element with an alkali liquid, and a step of heating the particle including a hydroxide of a tetravalent metal element.

### TECHNICAL FIELD

The present invention relates to an abrasive grain, a slurry, a polishing liquid and manufacturing methods therefor. In particular, the present invention relates to an abrasive grain, a slurry, a polishing liquid and manufacturing methods therefor, used in manufacturing steps of semiconductor elements.

### BACKGROUND ART

In manufacturing steps of semiconductor elements of recent years, processing techniques for densification and miniaturization are becoming increasingly important. CMP (Chemical Mechanical Polishing) technique, as one of the processing techniques, has become an essential technique for forming Shallow Trench Isolation (hereinafter, referred to as “STI” in some cases), flattening pre-metal insulating materials or interlayer insulating materials, and forming plugs or embedded metal wires, in manufacturing steps of semiconductor elements.

Conventionally, in manufacturing steps of semiconductor elements, insulating materials such as silicon oxide, which are formed by a CVD (Chemical Vapor Deposition) method, a spin-coating method or the like, are flattened by CMP. In the CMP, silica-based polishing liquids comprising silica particles such as colloidal silica and fumed silica as abrasive grains are generally used. The silica-based polishing liquids are manufactured by performing grain growth of abrasive grains by methods such as thermal decomposition of silicon tetrachloride and adjusting pH. However, these silica-based polishing liquids have a technical problem of a low polishing rate.

Incidentally, STI is used for element isolation in integrated circuits in the generation after a design rule of 0.25 μm. In STI formation, CMP is used for removing an extra part of an insulating material deposited on a base substrate. In order to stop polishing in CMP, a stopper (polishing stop layer) having a slow polishing rate is formed under the insulating material. Silicon nitride, polysilicon or the like is used for a stopper material (constituent material of stopper), and the polishing selection ratio of the insulating material with respect to the stopper material (polishing rate ratio: polishing rate of insulating material/polishing rate of stopper material) is desirably high. Conventional silica-based polishing liquids have a low polishing selection ratio of the insulating material with respect to the stopper material, about 3, and tend not to have properties which can withstand practical use for STI.

Moreover, in recent years, as cerium oxide-based polishing liquids, polishing liquids for semiconductors, using high-purity cerium oxide particles, have been used (for example, refer to the following Patent Literature 1).

Incidentally, in recent years, achievement of further miniaturization of wires has been required in manufacturing steps of semiconductor elements, and polishing scratch generated during polishing have become a problem. Specifically, when polishing is performed using conventional cerium oxide-based polishing liquids, generation of fine polishing scratch gives no problem as long as the size of the polishing scratch is smaller than the conventional wire width, but becomes a problem in the case where further miniaturization of wires is tried to be achieved.

For this problem, in the above-described cerium oxide-based polishing liquids, the average particle diameter of cerium oxide particles is tried to be reduced. However, if the average particle diameter is reduced, the polishing rate may be decreased due to a decrease in the mechanical action. Even if both a polishing rate and polishing scratch are tried to be achieved by controlling the average particle diameter of cerium oxide particles in this manner, it is extremely difficult to achieve the exacting requirement of recent years for polishing scratch while maintaining a polishing rate.

In response to this, polishing liquids using particles of a hydroxide of a tetravalent metal element have been studied (for example, refer to the following Patent Literature 2). Moreover, manufacturing methods of particles of a hydroxide of a tetravalent metal element have also been studied (for example, refer to the following Patent Literature 3). These techniques aim at reducing polishing scratch due to particles, by minimizing the mechanical action as much as possible while maintaining the chemical action of the particles of a hydroxide of a tetravalent metal element.

Furthermore, other than reducing of polishing scratch, a base substrate having irregularities is required to be flatly polished. Using the above-described STI as an example, the polishing selection ratio of the insulating material that is a material to be polished (for example, silicon oxide) is required to be improved with respect to the polishing rate of the stopper material (for example, silicon nitride, polysilicon). In order to solve them, addition of various additives to polishing liquids has been studied. For example, a technique for improving the polishing selection ratio in a base substrate having wires with different wire densities in the same plane by adding additives to polishing liquids is known (for example, refer to the following Patent Literature 4). Moreover, addition of additives to cerium oxide-based polishing liquids for controlling the polishing rate and improving global flatness is known (for example, refer to the following Patent Literature 5).

### CITATION LIST

### Patent Literature

Patent Literature 1: Japanese Patent Application Laid-Open No. 10-106994

Patent Literature 2: International Publication No. WO 02/067309

Patent Literature 3: Japanese Patent Application Laid-Open No. 2006-249129

Patent Literature 4: Japanese Patent Application Laid-Open No. 2002-241739

Patent Literature 5: Japanese Patent Application Laid-Open No. 08-022970

### SUMMARY OF INVENTION

### Technical Problem

However, it could not be said that the polishing rate is sufficiently high while reducing polishing scratch, by the techniques described in Patent Literatures 2 and 3. Since the polishing rate affects the efficiency of manufacturing processes, polishing liquids having a higher polishing rate are required.

Moreover, in conventional polishing liquids, if the polishing liquids comprise additives, the polishing rate is sometimes reduced in replacement of obtaining an addition effect of an additive, and there is a problem in that achievement of both a polishing rate and other polishing properties is difficult.

Furthermore, in conventional polishing liquids, storage stability is sometimes low. For example, there is a problem in that polishing properties are changed with time to be drastically decreased (stability of the polishing properties are low). Typical examples of the above-described polishing properties include a polishing rate, and there is a problem in that the polishing rate is decreased with time (stability of the polishing rate is low). Moreover, aggregation and precipitation of abrasive grains during storing occur, and these sometimes adversely affect the polishing properties (dispersion stability is low).

The present invention aims to solve the above-described problems, and it is an object of the present invention to provide an abrasive grain which produce a polishing liquid which can polish a material to be polished at an excellent polishing rate while maintaining an addition effect of an additive and can improve storage stability, and a manufacturing method therefor.

Moreover, it is an object of the present invention to provide a slurry which produces a polishing liquid which can polish a material to be polished at an excellent polishing rate while maintaining an addition effect of an additive and can improve storage stability, and a manufacturing method therefor.

Furthermore, it is an object of the present invention to provide a polishing liquid which can polish a material to be polished at an excellent polishing rate while maintaining an addition effect of an additive and can improve storage stability, and a manufacturing method therefor.

### Solution to Problem

The present inventors made extensive research on a method for manufacturing an abrasive grain including a hydroxide of a tetravalent metal element, and as a result, found that stability of the abrasive grain including a hydroxide of a tetravalent metal element and stability of a slurry and a polishing liquid which comprise the abrasive grain including a hydroxide of a tetravalent metal element are remarkably improved by mixing a metal salt solution comprising a salt of a tetravalent metal element with an alkali liquid to obtain a particle including a hydroxide of a tetravalent metal element, and then, heating the particle.

Specifically, the method for manufacturing an abrasive grain of the present invention comprises a step of obtaining a particle including a hydroxide of a tetravalent metal element by mixing a metal salt solution comprising a salt of the tetravalent metal element with an alkali liquid, and a step of heating the particle including a hydroxide of a tetravalent metal element.

According to the method for manufacturing an abrasive grain of the present invention, in the case where a polishing liquid comprising the abrasive grain obtained by the manufacturing method is used, a material to be polished can be polished at an excellent polishing rate while maintaining an addition effect of an additive, and storage stability can be improved. As the storage stability, in particular, dispersion stability and stability of a polishing rate can be improved. Moreover, according to the method for manufacturing an abrasive grain of the present invention, in the case where a slurry comprising the abrasive grain obtained by the manufacturing method is used for polishing, a material to be polished can be polished at an excellent polishing rate, and storage stability can also be improved. As the storage stability, in particular, dispersion stability and stability of a polishing rate can be improved. Furthermore, according to the method for manufacturing an abrasive grain of the present invention, the abrasive grain obtained by the manufacturing method includes a hydroxide of a tetravalent metal element so that generation of polishing scratch on a surface to be polished can also be suppressed.

In the method for manufacturing an abrasive grain of the present invention, the particle including a hydroxide of a tetravalent metal element is preferably heated at 30° C. or more, and the particle including a hydroxide of a tetravalent metal element is more preferably heated at 40° C. or more. In these cases, it becomes easier to further increase storage stability while maintaining an excellent polishing rate.

In the method for manufacturing an abrasive grain of the present invention, the particle including a hydroxide of a tetravalent metal element is preferably heated at 100° C. or less. In this case, stability of an abrasive grain can be further increased.

Moreover, the present inventors found that it becomes easier to obtain an abrasive grain capable of polishing a material to be polished at an excellent polishing rate by mixing the metal salt solution and the alkali liquid under a condition where the following parameter is a specific value or more. Specifically, in the method for manufacturing an abrasive grain of the present invention, the metal salt solution and the alkali liquid are preferably mixed under a condition where a parameter Z represented by the following expression (1) is 5.00 or more:

Z=[1/(ΔpH×k)]×(N/M)/1000 (1)

wherein, in the expression (1), ΔpH represents a variation in pH per minute of a mixed liquid of the metal salt solution and the alkali liquid, k represents a reaction temperature coefficient, N represents a circulation count (min⁻¹), and M represents a replacement count (min⁻¹).

The above-described ΔpH is preferably 1.000 or less. In this case, an abrasive grain capable of polishing a material to be polished at a further excellent polishing rate can be obtained.

The above-described circulation count N may be represented by the following expression (2):

N=(u×S)/Q (2)

wherein, in the expression (2), u represents a linear speed (m/min) of a stirring blade for stirring the mixed liquid, S represents an area (m²) of the stirring blade, and Q represents a liquid amount (m³) of the mixed liquid.

The above-described linear speed u is preferably 5.00 m/min or more in the following expression (3):

u=2π×R×r (3)

wherein, in the expression (3), R represents a rotational frequency (min⁻¹) of the stirring blade, and r represents a rotational radius (m) of the stirring blade. In this case, an abrasive grain capable of polishing a material to be polished at a further excellent polishing rate can be obtained.

The above-described rotational frequency R is preferably 30 min⁻¹ or more. In this case, an abrasive grain capable of polishing a material to be polished at a further excellent polishing rate can be obtained.

The above-described circulation count N is preferably 1.00 min⁻¹ or more. In this case, an abrasive grain capable of polishing a material to be polished at a further excellent polishing rate can be obtained.

The above-described replacement count M may be represented by the following expression (4):

M=v/Q (4)

wherein, in the expression (4), v represents a mixing rate (m³/min) of the metal salt solution and the alkali liquid, and Q represents a liquid amount (m³) of the mixed liquid.

The above-described mixing rate v is preferably 5.00×10⁻³ m³/min or less. In this case, an abrasive grain capable of polishing a material to be polished at a further excellent polishing rate can be obtained.

The above-described replacement count M is preferably 1.0 min⁻¹ or less. In this case, an abrasive grain capable of polishing a material to be polished at a further excellent polishing rate can be obtained.

The concentration of the salt of the tetravalent metal element in the metal salt solution is preferably 0.010 mol/L or more (It is to be noted that L represents “liter”, and the same shall apply hereafter.). In this case, an abrasive grain capable of polishing a material to be polished at a further excellent polishing rate can be obtained.

The alkali concentration in the alkali liquid is preferably 15.0 mol/L or less. In this case, an abrasive grain capable of polishing a material to be polished at a further excellent polishing rate can be obtained.

The pH of the mixed liquid of the metal salt solution and the alkali liquid is preferably 1.5 to 7.0. In this case, an abrasive grain capable of polishing a material to be polished at a further excellent polishing rate can be obtained.

The tetravalent metal element is preferably tetravalent cerium. In this case, an abrasive grain capable of polishing a material to be polished at a further excellent polishing rate can be obtained.

The method for manufacturing a slurry of the present invention comprises a step of obtaining a slurry by mixing the abrasive grain obtained by the above-described method for manufacturing an abrasive grain, and water. According to the method for manufacturing a slurry of the present invention, in the case where a polishing liquid obtained by adding an additive to the slurry obtained by the manufacturing method is used, a material to be polished can be polished at an excellent polishing rate while maintaining an addition effect of an additive, and storage stability can be improved. Moreover, according to the method for manufacturing a slurry of the present invention, in the case where the slurry obtained by the manufacturing method is used for polishing, a material to be polished can be polished at an excellent polishing rate, and storage stability can also be improved.

The method for manufacturing a polishing liquid of the present invention may be an aspect comprising a step of obtaining a polishing liquid by mixing the slurry obtained by the above-described method for manufacturing a slurry, and an additive, or may be an aspect comprising a step of obtaining a polishing liquid by mixing the abrasive grain obtained by the above-described method for manufacturing an abrasive grain, an additive, and water. According to the method for manufacturing a polishing liquid of the present invention, in the case where the polishing liquid obtained by the manufacturing method is used, a material to be polished can be polished at an excellent polishing rate while maintaining an addition effect of an additive, and storage stability can be improved.

The abrasive grain of the present invention is obtained by the above-described method for manufacturing an abrasive grain. The slurry of the present invention is obtained by the above-described method for manufacturing a slurry. The polishing liquid of the present invention is obtained by the above-described method for manufacturing a polishing liquid.

### Advantageous Effects of Invention

According to the abrasive grain and the manufacturing method therefor of the present invention, in the case where the polishing liquid comprising the abrasive grain is used, a material to be polished can be polished at an excellent polishing rate while maintaining an addition effect of an additive, and storage stability can be improved. Moreover, according to the abrasive grain and the manufacturing method therefor of the present invention, in the case where the polishing liquid obtained by adding an additive to the slurry comprising the abrasive grain is used, a material to be polished can be polished at an excellent polishing rate while maintaining an addition effect of an additive, and storage stability can be improved. According to the abrasive grain and the manufacturing method therefor of the present invention, in the case where the slurry comprising the abrasive grain is used for polishing, a material to be polished can be polished at an excellent polishing rate, and storage stability can also be improved. Furthermore, according to the abrasive grain and the manufacturing method therefor of the present invention, the abrasive grain includes a hydroxide of a tetravalent metal element so that generation of polishing scratch on a surface to be polished can also be suppressed.

According to the slurry and the manufacturing method therefor of the present invention, in the case where the polishing liquid obtained by adding an additive to the slurry is used, a material to be polished can be polished at an excellent polishing rate while maintaining an addition effect of an additive, and storage stability can be improved. According to the slurry and the manufacturing method therefor of the present invention, in the case where the slurry is used for polishing, a material to be polished can be polished at an excellent polishing rate, and storage stability can be improved.

According to the polishing liquid and the manufacturing method therefor of the present invention, in the case where the polishing liquid is used for polishing, a material to be polished can be polished at an excellent polishing rate, and storage stability can be improved.

It is to be noted that, regarding the above-described storage stability, according to the present invention, even in the case where polishing is performed using the abrasive grain after being stored at 60° C. for 3 days (72 hours), for example, a polishing rate change ratio can be decreased based on the polishing rate before storing (for example, kept within 5.0%).

Moreover, according to the present invention, uses of the above-described abrasive grain, slurry and polishing liquid for a flattening step of a base substrate surface in manufacturing steps of semiconductor elements are provided. In particular, according to the present invention, uses of the above-described abrasive grain, slurry and polishing liquid for a flattening step of shallow trench isolation insulating materials, pre-metal insulating materials, interlayer insulating materials or the like are provided.

### BRIEF DESCRIPTION OF DRAWINGS

FIG. 1 is a schematic diagram showing the aggregated condition of abrasive grains when an additive is added.

FIG. 2 is a schematic diagram showing the aggregated condition of abrasive grains when an additive is added.

### DESCRIPTION OF EMBODIMENTS

Hereinafter, embodiments of the present invention will be described in detail. It is to be noted that the present invention is not limited to the following embodiments and may be embodied in various ways within the scope of the present invention. In the present description, a “slurry” and a “polishing liquid” are compositions which contact a material to be polished during polishing, and comprise at least water and abrasive grains. Moreover, an “aqueous dispersion” having a content of the abrasive grains adjusted to a predetermined amount means a liquid comprising a predetermined amount of the abrasive grains and water.

<Manufacture of Abrasive Grains>

The abrasive grains of the present embodiment include a hydroxide of a tetravalent metal element. A manufacturing method for obtaining such abrasive grains comprises a reaction step of obtaining particles including a hydroxide of a tetravalent metal element (hereinafter, referred to as “particles of a hydroxide of a tetravalent metal element”) by mixing a metal salt solution comprising a salt of a tetravalent metal element (first liquid, for example, metal salt aqueous solution) with an alkali liquid comprising an alkali source (base) (second liquid, for example, alkali aqueous solution) to react the salt of a tetravalent metal element with the alkali source, and a heating step of obtaining abrasive grains including a hydroxide of a tetravalent metal element by heating the particles of a hydroxide of a tetravalent metal element obtained in the reaction step. According to the manufacturing method, particles having an extremely fine particle diameter can be obtained, and abrasive grains which excel in a polishing scratch reducing effect can be obtained.

It is to be noted that, in the reaction step, a means for stirring a mixed liquid obtained by mixing the metal salt solution with the alkali liquid is not limited, and examples thereof include a method of stirring the mixed liquid using a rod-like, plate-like or propeller-like stirrer, or stirring blade, which rotates around a rotation axis; a method of stirring the mixed liquid by rotating a stirrer using a magnetic stirrer which transmits power from the outside of a container with a rotating magnetic field; a method of stirring the mixed liquid with a pump placed on the outside of a tank; and a method of stirring the mixed liquid by pressurizing outside air and furiously blowing it into a tank. Moreover, examples of a method for heating the particles of a hydroxide of a tetravalent metal element in the heating step include a method of directly heating the mixed liquid obtained by mixing the metal salt solution with the alkali liquid using a heat source such as a heater; and a method of heating the mixed liquid by vibration generated from an ultrasonic wave oscillator.

The present inventors found that a polishing rate can be improved and storage stability can be improved by using the abrasive grains obtained after the above-described heating step. The reason for this is not necessarily clear, but the present inventors conjecture as follows.

Specifically, it is thought that, depending on manufacturing conditions of the hydroxide of a tetravalent metal element and the like, particles including M(OH)ₐX_{b} composed of a tetravalent metal (M⁴⁺), 1 to 3 hydroxide ions (OH⁻), and 1 to 3 anions (X^{c-}) (in the formula, a+b×c=4) are generated as a part of the abrasive grains (it is to be noted that the foregoing particles are also “the abrasive grains including the hydroxide of a tetravalent metal element”). It is thought that, in M(OH)ₐX_{b}, the electron-withdrawing anions (X^{c-}) act to improve the reactivity of the hydroxide ions and the polishing rate is improved as the abundance of M(OH)ₐX_{b} is increased.

It is thought that the abrasive grains including the hydroxide of a tetravalent metal element can include not only M(OH)ₐX_{b} but also M(OH)₄, MO₂ and the like, Examples of the anions (X^{c-}) include NO₃⁻, SO₄²⁻ and the like.

It is to be noted that the inclusion of M(OH)ₐX_{b} in the abrasive grains can be confirmed by a method for detecting a peak corresponding to the anions (X^{c-}) with the FT-IR AIR method (Fourier transform Infra Red Spectrometer Attenuated Total Reflection Method) after washing the abrasive grains with pure water well. The existence of the anions (X^{c-}) can also be confirmed by the XPS method (X-ray Photoelectron Spectroscopy).

On the other hand, the calculation of structure stability of the particles of a hydroxide of a tetravalent metal element, such as particles including M(OH)ₐX_{b} (for example, M(OH)₃X), has shown that the structure stability of the particles is decreased as the abundance of the anions (X^{c-}) is increased. It is thought that, in the particles of a hydroxide of a tetravalent metal element including the anions (X^{c-}), a part of the anions (X^{c-}) is desorbed from the particles with time, and thus, storage stability is sometimes decreased. In this regard, it is thought that, by granulating the particles of a hydroxide of a tetravalent metal element, and then, by heating the particles, anions (X^{c-}) to be desorbed from the particles are desorbed from the particles in advance, and thus, storage stability can be improved while maintaining an excellent polishing rate.

From the viewpoint of making it easier to further increase storage stability while maintaining an excellent polishing rate by making it easier to obtain a heating effect, the heating temperature in the heating step is preferably 30° C. or more, more preferably 35° C. or more, further preferably 38° C. or more, particularly preferably 40° C. or more, and extremely preferably 50° C. or more. From the viewpoint of suppressing boiling of water or the like, which is a solvent, and from the viewpoint of suppressing oxidation and aggregation of the particles, the heating temperature is preferably 100° C. or less, more preferably 90° C. or less, further preferably 85° C. or less, and particularly preferably 80° C. or less.

From the viewpoint of making it easier to obtain a sufficient stabilizing effect, the heating time in the heating step is preferably 3 hours or more, more preferably 6 hours or more, further preferably 9 hours or more, particularly preferably 18 hours or more, and extremely preferably 24 hours or more. From the viewpoint of productivity, and from the viewpoint of suppressing aggregation of the particles, the heating time is preferably 720 hours or less, more preferably 480 hours or less, and further preferably 240 hours or less.

Examples of the salt of a tetravalent metal element include M(NO₃)₄, M(SO₄)₂, M(NH₄)₂(NO₃)₆ and M(NH₄)₄(SO₄)₄, in which a metal is indicated by M. These salts can be used singly or in combinations of two or more.

From the viewpoint of moderating an increase in pH, the lower limit of the concentration of the salt of a tetravalent metal element (metal salt concentration) Cₐ in the metal salt solution is preferably 0.010 mol/L or more, more preferably 0.020 mol/L or more, and further preferably 0.030 mol/L or more, based on the total of the metal salt solution. The upper limit of the metal salt concentration Cₐ is not particularly limited, but from the viewpoint of ease of handling, it is preferably 1.000 mol/L or less, more preferably 0.800 mol/L or less, further preferably 0.500 mol/L or less, and particularly preferably 0.300 mol/L or less, based on the total of the metal salt solution.

The alkali source of the alkali liquid is not particularly limited, but examples thereof include organic bases and inorganic bases. Examples of the organic bases include nitrogen-containing organic bases such as guanidine, triethylamine, and chitosan; nitrogen-containing heterocyclic organic bases such as pyridine, piperidine, pyrrolidine, and imidazole; and ammonium salts such as ammonium carbonate, ammonium hydrogen carbonate, tetramethylammonium hydroxide, tetraethylammonium hydroxide, tetramethylammonium chloride, and tetraethylammonium chloride. Examples of the inorganic bases include ammonia, and inorganic salts of alkali metal, such as lithium hydroxide, sodium hydroxide, potassium hydroxide, calcium hydroxide, lithium carbonate, sodium carbonate, potassium carbonate, lithium hydrogen carbonate, sodium hydrogen carbonate, and potassium hydrogen carbonate. The alkali sources can be used singly or in combinations of two or more.

From the viewpoint of making it easier to suppress a rapid reaction, the alkali source preferably exhibits weak basicity. Among the alkali sources, nitrogen-containing heterocyclic organic bases are preferable, and among them, pyridine, piperidine, pyrrolidine and imidazole are more preferable, pyridine and imidazole are further preferable, and imidazole is particularly preferable.

From the viewpoint of moderating an increase in pH, the upper limit of the alkali concentration (concentration of base, concentration of alkali source) C_{b} in the alkali liquid is preferably 15.0 mol/L or less, more preferably 12.0 mol/L or less, further preferably 10.0 mol/L or less, and particularly preferably 5.0 mol/L or less, based on the total of the alkali liquid. The lower limit of the alkali concentration C_{b} is not particularly limited, but from the viewpoint of productivity, it is preferably 0.001 mol/L or more based on the total of the alkali liquid.

It is preferable that the alkali concentration in the alkali liquid be adjusted as appropriate depending on the alkali source selected. For example, in the case of an alkali source having pKa of conjugate acid of the alkali source of 20 or more, from the viewpoint of moderating an increase in pH, the upper limit of the alkali concentration is preferably 0.10 mol/L or less, more preferably 0.05 mol/L or less, and further preferably 0.01 mol/L or less, based on the total of the alkali liquid. The lower limit of the alkali concentration is not particularly limited, but from the viewpoint of productivity, it is preferably 0.001 mol/L or more based on the total of the alkali liquid.

In the case of an alkali source having pKa of conjugate acid of the alkali source of 12 or more and less than 20, from the viewpoint of moderating an increase in pH, the upper limit of the alkali concentration is preferably 1.0 mol/L or less, more preferably 0.50 mol/L or less, and further preferably 0.10 mol/L or less, based on the total of the alkali liquid. The lower limit of the alkali concentration is not particularly limited, but from the viewpoint of productivity, it is preferably 0.01 mol/L or more based on the total of the alkali liquid.

In the case of an alkali source having pKa of conjugate acid of the alkali source of less than 12, from the viewpoint of moderating an increase in pH, the upper limit of the alkali concentration is preferably 15.0 mol/L or less, more preferably 10.0 mol/L or less, and further preferably 5.0 mol/L or less, based on the total of the alkali liquid. The lower limit of the alkali concentration is not particularly limited, but from the viewpoint of productivity, it is preferably 0.1 mol/L or more based on the total of the alkali liquid.

Regarding specific alkali sources, examples of the alkali source having pKa of conjugate acid of the alkali source of 20 or more include 1,8-diazabicyclo[5.4.0]undec-7-ene (pKa: 25). Examples of the alkali source having pKa of conjugate acid of the alkali source of 12 or more and less than 20 include potassium hydroxide (pKa: 16) and sodium hydroxide (pKa: 13). Examples of the alkali source having pKa of conjugate acid of the alkali source of less than 12 include ammonia (pKa: 9) and imidazole (pKa: 7). The pKa value of conjugate acid of the alkali source used is not particularly limited as long as the alkali concentration is appropriately adjusted, but pKa of conjugate acid of the alkali source is preferably less than 20, more preferably less than 12, further preferably less than 10, and particularly preferably less than 8.

From the viewpoint of stability of the mixed liquid, the pH of the mixed liquid obtained by mixing the metal salt solution with the alkali liquid is preferably 1.5 or more, more preferably 1.8 or more, and further preferably 2.0 or more, in a stable state after mixing the metal salt solution with the alkali liquid. From the viewpoint of stability of the mixed liquid, the pH of the mixed liquid is preferably 7.0 or less, more preferably 6.0 or less, and further preferably 5.5 or less.

The pH of the mixed liquid can be measured with a pH meter (for example, model number PH81 manufactured by Yokogawa Electric Corporation). As the pH, for example, after two-point calibration using a standard buffer (phthalate pH buffer: pH 4.01 (25° C.) and a neutral phosphate pH buffer: pH 6.86 (25° C.)), an electrode is placed in a liquid to be measured, and a value stabilized after a lapse of 2 minutes or more is used.

The particles of a hydroxide of a tetravalent metal element are preferably obtained by mixing the metal salt solution and the alkali liquid to react the salt of a tetravalent metal element with the alkali source under a condition where a parameter Z represented by the following expression (1) is 5.00 or more.

Z=[1/(ΔpH×k)]×(N/M)/1000 (1)

[In the expression (1), ΔpH represents a variation in pH per minute of the mixed liquid, k represents a reaction temperature coefficient, N represents a circulation count (min⁻¹), and M represents a replacement count (min⁻¹).]

Abrasive grains obtained by the manufacturing method satisfying the condition of the parameter Z are easy to satisfy Condition (a) below, and are easy to satisfy at least one of Condition (b) and Condition (c).

Condition (a): producing absorbance of 1.00 or more for light having a wavelength of 400 nm in an aqueous dispersion having a content of the abrasive grains adjusted to 1.0 mass %.

Condition (b): producing light transmittance of 50%/cm or more for light having a wavelength of 500 nm in an aqueous dispersion having a content of the abrasive grains adjusted to 1.0 mass %.

Condition (c): producing absorbance of 1.000 or more for light having a wavelength of 290 nm in an aqueous dispersion having a content of the abrasive grains adjusted to 0.0065 mass % (65 ppm). It is to be noted that “ppm” means mass ppm, that is, “parts per million mass”.

The present inventors found that, in the case where abrasive grains obtained after the above-described heating step satisfy Condition (a), a material to be polished becomes easy to be polished at an excellent polishing rate and storage stability becomes easy to be improved. Moreover, it was found that, in the case where the above-described abrasive grains further satisfy at least one of Condition (b) and Condition (c), a material to be polished becomes easy to be polished at a further excellent polishing rate and storage stability becomes easy to be improved. Moreover, the present inventors found that a polishing liquid and a slurry comprising abrasive grains which satisfy the above-described conditions have slightly yellowishness when visually observed, and that a polishing rate is improved as the yellowishness of the polishing liquid and the slurry becomes deep.

(Parameter Z)

Based on the study, the present inventors found that, particles of a hydroxide of a tetravalent metal element, which can polish a material to be polished at an excellent polishing rate and has high storage stability, become easy to be obtained by making a reaction of the salt of a tetravalent metal element with the alkali source proceed moderately and uniformly, in manufacturing the particles of a hydroxide of a tetravalent metal element. Based on such knowledge, the present inventors found that particles of a hydroxide of a tetravalent metal element, which can polish a material to be polished at an excellent polishing rate and have high storage stability, become easy to be manufactured by controlling the parameter Z of the expression (1). Specifically, the above-described particles of a hydroxide of a tetravalent metal element become easy to be manufactured by controlling each parameter of the expression (1) such that the parameter Z becomes large.

The present inventors set the parameter Z of the expression (1) based on the above-described knowledge. For explaining the expression (1), the expression (1) will be considered by being separated into the following two elements.

Element A: [1/(ΔpH×k)]

Element B: (N/M)

Element A is set as an index relating mainly to reactivity in the present synthesis. Based on the study, the variation in pH per unit time (1 minute) of the mixed liquid, ΔpH, is preferably small, and it is presumed that the reaction proceeds moderately as ΔpH is smaller. Therefore, ΔpH was set to be in the denominator in the expression (1).

The reaction temperature coefficient k is represented by the following expression (5), for example. The present inventors found that, while stability of the particles tends to be increased by increasing the temperature T of the mixed liquid, it tends to become difficult to achieve both a polishing rate and storage stability because the reaction proceeds intensively in the case where the reaction temperature coefficient k is high. Based on the study, from the viewpoint of making it easier to achieve both a polishing rate and storage stability, the reaction temperature coefficient k is preferably small, and it is presumed that the reaction proceeds moderately as the reaction temperature coefficient k is smaller (that is, as the temperature T is lower). Therefore, k was set to be in the denominator in the expression (1).

k=2^{[(T-20)/10]} (5)

[In the expression (5), T represents a temperature (° C.) of the mixed liquid.]

On the other hand, Element B was set as an index relating mainly to reactivity in the present synthesis and diffusivity of the solution. The circulation count N is an index indicating a degree of the speed of diffusion when two or more substances are mixed. Based on the study, the circulation count N is preferably large, and it is presumed that, as the circulation count N is larger, the metal salt solution and the alkali liquid are uniformly mixed, and thus, the reaction proceeds uniformly. Therefore, the circulation count N was set to be in the numerator in the expression (1).

The above-described circulation count N has different calculation expressions depending on stirring means used, but the calculation method itself is known to those skilled in the art. For example, it is described in detail in “Handbook of Chemical Engineering (5th Edition)” edited by The Society of Chemical Engineers, Japan, MARUZEN Co., Ltd., or “Chemical Engineering Description and Exercises” edited by The Society of Chemical Engineers, Japan, Maki Shoten. By taking the case of performing the reaction using a stirring blade for example, the circulation count N is represented by the following expression (2), for example, and is dependent on the linear speed u of the stirring blade, the area S of the stirring blade for stirring the mixed liquid, and the liquid amount Q of the mixed liquid in the expression (2). The linear speed u is represented by the following expression (3), for example, and is dependent on the rotational frequency R and the rotational radius r of the stirring blade.

N=(u×S)/Q (2)

[In the expression (2), u represents a linear speed (m/min) of the stirring blade for stirring the above-described mixed liquid, S represents an area (m²) of the stirring blade, and Q represents a liquid amount (m³) of the above-described mixed liquid.]

u=ω×r=2π×R×r (3)

[In the expression (3), ω represents an angular velocity (rad/min) of the stirring blade, R represents a rotational frequency (min⁻¹) of the stirring blade, and r represents a rotational radius (m) of the stirring blade.]

Moreover, in the case where stirring means other than the stirring blade (for example, circulation with pump, stirring by blowing gas) are used, N can be calculated by replacing the above-described u×S with a circulation flow amount F (m³/min). Specifically, it can be determined as:

N=F/Q (2′).

The replacement count M is an index indicating the rate of replacement of a substance A with another substance B when the substance B is mixed into the substance A. Based on the study, the replacement count M is preferably small, and it is presumed that the reaction proceeds moderately as the replacement count M is smaller. Therefore, the replacement count M was set to be in the denominator in the expression (1). The replacement count M is represented by the following expression (4), for example, and is dependent on the mixing rate v and the liquid amount Q of the mixed liquid.

M=v/Q (4)

[In the expression (4), v represents a mixing rate (m³/min) of the metal salt solution and the alkali liquid, and Q represents a liquid amount (m³) of the above-described mixed liquid.]

It is thought that these parameters set by Element A and Element B work and contribute together rather than individually contribute to reactivity and diffusivity of the reactants in the forming reaction of the particles of a hydroxide of a tetravalent metal element. Since they are considered to act not merely additively but synergistically, the product of Element A and Element B was set in the expression (1). Finally, the product of Element A and Element B is divided by 1000 for convenience to obtain the parameter Z, and thus, the expression (1) was obtained.

From the viewpoint of making it easier to obtain particles of a hydroxide of a tetravalent metal element, which can polish a material to be polished at an excellent polishing rate, the lower limit of the parameter Z is more preferably 7.50 or more, further preferably 10.00 or more, and particularly preferably 12.50 or more. From the viewpoint of making it easier to obtain particles of a hydroxide of a tetravalent metal element, which can polish a material to be polished at an excellent polishing rate, and from the viewpoint of excelling in productivity, the upper limit of the parameter Z is preferably 5000.00 or less.

By controlling each parameter in the above-described expression (1), the parameter Z can be adjusted to a predetermined value. Hereinafter, each parameter used when adjusting the parameter Z will be described in further detail.

(Variation in pH: ΔpH)

The variation in pH, ΔpH, is the average value of a variation in pH per unit time (1 minute) from the start of mixing the metal salt solution and the alkali liquid until the pH of the mixed liquid reaches and stabilizes at a constant pH. By controlling ΔpH, the value of the parameter Z can be increased. Specifically, by keeping ΔpH low, the value of the parameter Z tends to be increased. A specific means for achieving this may be increasing the metal salt concentration in the metal salt solution, lowering the alkali concentration in the alkali liquid, or using a weakly basic alkali source as the alkali source in the alkali liquid.

From the viewpoint of further suppressing a rapid reaction, the upper limit of ΔpH is preferably 1.000 or less, and more preferably 0.500 or less, per unit time. The lower limit of ΔpH is not particularly limited, but from the viewpoint of productivity, it is preferably 0.0001 or more per unit time.

(Reaction Temperature: T)

By controlling the temperature T of the mixed liquid in the reaction step (hereinafter, referred to as “reaction temperature T” in some cases), the parameter Z can be increased. Specifically, by lowering the reaction temperature T, that is, lowering the reaction temperature coefficient k, the value of the parameter Z tends to be increased.

The reaction temperature T is, for example, a temperature of the mixed liquid which can be read with a thermometer placed in the mixed liquid, and is preferably 0 to 100° C. From the viewpoint of further suppressing a rapid reaction, the reaction temperature T is preferably 100° C. or less, more preferably 60° C. or less, further preferably 50° C. or less, particularly preferably 40° C. or less, extremely preferably 30° C. or less, and very preferably 25° C. or less. From the viewpoint of making a reaction easily proceed, the reaction temperature T is preferably 0° C. or more, more preferably 5° C. or more, further preferably 10° C. or more, particularly preferably 15° C. or more, and extremely preferably 20° C. or more.

The salt of a tetravalent metal element of the metal salt solution and the alkali source of the alkali liquid are preferably reacted at a constant reaction temperature T (for example, within a temperature range of the reaction temperature T±3° C.). It is to be noted that an adjusting method of the reaction temperature is not particularly limited, and examples thereof include a method in which a container containing either the metal salt solution or the alkali liquid therein is placed in a water tank filled with water, and the metal salt solution and the alkali liquid are mixed while adjusting the water temperature of the water tank using an external-circulating device Coolnics Circulator (manufactured by Tokyo Rikakikai Co., Ltd. (EYELA), product name Cooling Thermopump CTP101).

(Circulation Count: N)

From the viewpoint of further suppressing bias of a reaction in a limited part, the lower limit of the circulation count N is preferably 1.00 min⁻¹ or more, more preferably 10.00 min⁻¹ or more, further preferably 15.00 min⁻¹ or more, and particularly preferably 20.00 min⁻¹ or more. The upper limit of the circulation count N is not particularly limited, but from the viewpoint of suppressing splash of a liquid during manufacture, it is preferably 200.00 min⁻¹ or less, and more preferably 150.00 min⁻¹ or less.

(Linear Speed: u)

The linear speed indicates a flow amount of a fluid per unit time (1 minute) and unit area (m²), and is an index indicating diffusion degree of a substance. The linear speed u in the present embodiment means the linear speed of the stirring blade in mixing the metal salt solution and the alkali liquid. By controlling the linear speed u, the parameter Z can be increased. Specifically, by increasing the linear speed u, the value of the parameter Z tends to be increased.

From the viewpoint of further suppressing non-uniformity of a reaction, which occurs because a substance fails to suitably diffuse and the substance is localized, the lower limit of the linear speed u represented by the expression (3) is preferably 5.00 m/min or more, more preferably 10.00 m/min or more, further preferably 20.00 m/min or more, particularly preferably 50.00 m/min or more, and extremely preferably 70.00 m/min or more. The upper limit of the linear speed u is not particularly limited, but from the viewpoint of suppressing splash of a liquid during manufacture, it is preferably 200.00 m/min or less.

(Area of Stirring Blade: S)

The area S of the stirring blade for stirring the mixed liquid means the surface area of one side of the stirring blade, and in the case where there are multiple stirring blades, it means the sum of the areas of the respective stirring blades. By controlling the area S, the parameter Z can be increased. Specifically, by increasing the area S, the value of the parameter Z tends to be increased.

The area S is adjusted depending on the size of the liquid amount Q of the mixed liquid. For example, in the case where the liquid amount Q of the mixed liquid is 0.0010 to 0.0050 m³, the area S is preferably 0.0005 to 0.0100 m².

(Liquid Amount of Mixed Liquid: Q)

The liquid amount Q of the mixed liquid is the total liquid amount of the liquid amount of the metal salt solution and the liquid amount (Q_{b}) of the alkali liquid. For example, in the case of using a 50 mass % metal salt solution as a raw material, it is the total liquid amount of the liquid amount (Qₐ) of the 50 mass % metal salt solution, the liquid amount (Q_{w}) of water for diluting it, and the liquid amount (Q_{b}) of the alkali liquid. The liquid amount of the mixed liquid is not particularly limited, and is 0.0010 to 10.00 m³, for example. The liquid amount Q included in the circulation count N in the expression (2) and the liquid amount Q included in the replacement count M in the expression (4) cancel each other out, and the parameter Z tends not to largely depend on the value of the liquid volume Q.

(Rotational Frequency of Stirring Blade: R)

By controlling the rotational frequency R, the parameter Z can be increased. Specifically, by increasing the rotational frequency R, the value of the parameter Z tends to be increased.

From the viewpoint of mixing efficiency, the lower limit of the rotational frequency R is preferably 30 min⁻¹ or more, more preferably 100 min⁻¹ or more, and further preferably 300 min⁻¹ or more. The upper limit of the rotational frequency R is not particularly limited, and it needs to be adjusted as appropriate depending on the size and the shape of the stirring blade, but from the viewpoint of suppressing splash of a liquid, it is preferably 1000 min⁻¹ or less.

(Rotational Radius of Stirring Blade: r)

By controlling the rotational radius r, the parameter Z can be increased. Specifically, by increasing the rotational radius r, the value of the parameter Z tends to be increased.

From the viewpoint of stirring efficiency, the lower limit of the rotational radius r is preferably 0.001 m or more, and more preferably 0.01 m or more. The upper limit of the rotational radius r is not particularly limited, but from the viewpoint of ease of handling, it is preferably 10 m or less. It is to be noted that, in the case where there are multiple stirring blades, the average value of the rotational radius is preferably within the above-described range.

(Replacement Count: M)

By controlling the replacement count M, the parameter Z can be increased. Specifically, by decreasing the replacement count M, the value of the parameter Z tends to be increased.

From the viewpoint of further suppressing rapid progression of a reaction, the upper limit of the replacement count M is preferably 1.0 min⁻¹ or less, more preferably 0.1 min⁻¹ or less, further preferably 0.02 min⁻¹ or less, and particularly preferably 0.01 min⁻¹ or less. The lower limit of the replacement count M is not particularly limited, but from the viewpoint of productivity, it is preferably 1.0×10⁻⁵ min⁻¹ or more.

(Mixing Rate: v)

The mixing rate v means the supply rate of a liquid A, which is one of the metal salt solution and the alkali liquid, when the liquid A is supplied to the other liquid B. By controlling the mixing rate v, the parameter Z can be increased. Specifically, by slowing the mixing rate v, the value of the parameter Z tends to be increased.

From the viewpoint of further suppressing rapid progression of a reaction and further suppressing bias of a reaction in a limited part, the upper limit of the mixing rate v is preferably 5.00×10⁻³ m³/min (5 L/min) or less, more preferably 1.00×10⁻³ m³/min (1 L/min) or less, further preferably 5.00×10⁴ m³/min (500 mL/min) or less, and particularly preferably 1.00×10⁻⁴ m³/min (100 mL/min) or less. The lower limit of the mixing rate v is not particularly limited, but from the viewpoint of productivity, it is preferably 1.00×10⁻⁷ m³/min (0.1 mL/min) or more.

The particles of a hydroxide of a tetravalent metal element prepared as described above sometimes include impurities, and the impurities may be removed. A method for removing the impurities is not particularly limited, and examples thereof include methods such as centrifugation, filter press and ultrafiltration. This makes it possible to adjust absorbance for light having a wavelength of 450 to 600 nm described below. It is to be noted that the mixed liquid obtained by mixing the metal salt solution and the alkali liquid comprises the particles of a hydroxide of a tetravalent metal element, and a material to be polished may be polished using the mixed liquid.

<Manufacture of Slurry>

The method for manufacturing a slurry of the present embodiment comprises an abrasive grain manufacturing step of obtaining abrasive grains by the above-described method for manufacturing abrasive grains, and a slurry manufacturing step of obtaining a slurry by mixing the abrasive grains obtained in the abrasive grain manufacturing step, and water. In the slurry manufacturing step, the above-described abrasive grains are dispersed into water. A method for dispersing the above-described abrasive grains into water is not particularly limited, and examples thereof include a dispersing method by stirring; and a dispersing method with a homogenizer, an ultrasonic disperser, a wet ball mill or the like. It is to be noted that a slurry may be obtained by mixing the abrasive grains obtained in the abrasive grain manufacturing step, another type of abrasive grains, and water.

<Manufacture of Polishing Liquid>

The method for manufacturing a polishing liquid may be an aspect comprising the slurry manufacturing step of obtaining the slurry by the above-described method for manufacturing the slurry, and a polishing liquid preparing step of obtaining a polishing liquid by mixing the slurry and an additive. In this case, liquids may be prepared as a so-called two-pack type polishing liquid separated into a slurry comprising abrasive grains and an additive liquid comprising an additive, and a polishing liquid may be obtained by mixing the slurry and the additive liquid. Moreover, the method for manufacturing a polishing liquid may be an aspect comprising the above-described abrasive grain manufacturing step, and a polishing liquid preparing step of obtaining a polishing liquid by mixing the abrasive grains obtained in the abrasive grain manufacturing step, an additive, and water. In this case, the abrasive grains obtained in the abrasive grain manufacturing step, another type of abrasive grains, and water may be mixed.

<Polishing Liquid>

The polishing liquid of the present embodiment comprises at least abrasive grains, an additive and water. Hereinafter, each of the constituent components will be described.

(Abrasive Grains)

The abrasive grains are characterized by including a hydroxide of a tetravalent metal element. The “hydroxide of a tetravalent metal element” is a compound including a tetravalent metal (M⁴⁺) and at least one hydroxide ion (OH⁻). The hydroxide of a tetravalent metal element may include an anion other than the hydroxide ion (for example, nitrate ion NO₃⁻, sulfate ion SO₄²⁻). For example, the hydroxide of a tetravalent metal element may include an anion (for example, nitrate ion NO₃⁻, sulfate ion SO₄²⁻) bonded to the tetravalent metal element.

The tetravalent metal element is preferably at least one selected from the group consisting of rare earth elements and zirconium. From the viewpoint of further improving a polishing rate, the tetravalent metal element is preferably rare earth elements. Examples of rare earth elements which can be tetravalent include lanthanoids such as cerium, praseodymium and terbium, and among them, from the viewpoint of easy availability and further excelling in a polishing rate, cerium (tetravalent cerium) is preferable. A hydroxide of a rare earth element and a hydroxide of zirconium may be used together, two or more kinds may be selected from hydroxides of rare earth elements to be used.

The polishing liquid of the present embodiment may use other kinds of abrasive grains together within a range not impairing properties of the abrasive grains including the hydroxide of a tetravalent metal element. Specifically, abrasive grains of silica, alumina, zirconia or the like may be used.

The content of the hydroxide of a tetravalent metal element in the abrasive grains is preferably 50 mass % or more, more preferably 60 mass % or more, further preferably 70 mass % or more, particularly preferably 80 mass % or more, extremely preferably 90 mass % or more, very preferably 95 mass % or more, still further preferably 98 mass % or more, and further preferably 99 mass % or more, based on the total mass of the abrasive grains. It is particularly preferable that the abrasive grains be substantially made of the hydroxide of a tetravalent metal element (substantial 100 mass % of the abrasive grains is particles of the hydroxide of a tetravalent metal element).

The content of the hydroxide of tetravalent cerium in the abrasive grains is preferably 50 mass % or more, more preferably 60 mass % or more, further preferably 70 mass % or more, particularly preferably 80 mass % or more, extremely preferably 90 mass % or more, very preferably 95 mass % or more, still further preferably 98 mass % or more, and further preferably 99 mass % or more, based on the total mass of the abrasive grains. It is particularly preferable that the abrasive grains be substantially made of the hydroxide of tetravalent cerium (substantial 100 mass % of the abrasive grains is particles of the hydroxide of tetravalent cerium) from the viewpoint of high chemical activity and further excelling in a polishing rate.

In the constituent components of the polishing liquid of the present embodiment, the hydroxide of a tetravalent metal element is thought to have a significant impact on polishing properties. Thus, by adjusting the content of the hydroxide of a tetravalent metal element, a chemical interaction between the abrasive grains and a surface to be polished is improved, and the polishing rate can be further improved. Specifically, the content of the hydroxide of a tetravalent metal element is preferably 0.01 mass % or more, more preferably 0.03 mass % or more, and further preferably 0.05 mass % or more, based on the total mass of the polishing liquid, from the viewpoint of making it easier to sufficiently exhibit the function of the hydroxide of a tetravalent metal element. The content of the hydroxide of a tetravalent metal element is preferably 8 mass % or less, more preferably 5 mass % or less, further preferably 3 mass % or less, particularly preferably 1 mass % or less, extremely preferably 0.5 mass % or less, and very preferably 0.3 mass % or less, based on the total mass of the polishing liquid, from the viewpoint of making it easier to avoid aggregation of the abrasive grains, and from the viewpoint of obtaining a favorable chemical interaction with the surface to be polished, and capable of effectively using properties of the abrasive grains.

In the polishing liquid of the present embodiment, the lower limit of the content of the abrasive grains is not particularly limited, but from the viewpoint of making it easier to obtain an intended polishing rate, it is preferably 0.01 mass % or more, more preferably 0.03 mass % or more, and further preferably 0.05 mass % or more, based on the total mass of the polishing liquid. The upper limit of the content of the abrasive grains is not particularly limited, but from the viewpoint of making it easier to avoid aggregation of the abrasive grains and allowing the abrasive grains to effectively act on the surface to be polished to smoothly promote polishing, it is preferably 10 mass % or less, more preferably 5 mass % or less, further preferably 3 mass % or less, particularly preferably 1 mass % or less, extremely preferably 0.5 mass % or less, and very preferably 0.3 mass % or less, based on the total mass of the polishing liquid.

In the case where the average secondary particle diameter (hereinafter referred to as “average particle diameter” unless otherwise noted) of the abrasive grains is to some extent small, the specific surface area of the abrasive grains which contact the surface to be polished is increased and thus, the polishing rate can be further improved, and the mechanical action is suppressed and thus, polishing scratch can be further reduced. Therefore, the upper limit of the average particle diameter is preferably 200 nm or less, more preferably 150 nm or less, further preferably 100 nm or less, particularly preferably 80 nm or less, extremely preferably 60 nm or less, and very preferably 40 nm or less, from the viewpoint of obtaining a further excellent polishing rate and capable of further reducing polishing scratch. The lower limit of the average particle diameter is preferably 1 nm or more, more preferably 2 nm or more, and further preferably 3 nm or more, from the viewpoint of obtaining a further excellent polishing rate and capable of further reducing polishing scratch.

The average particle diameter of the abrasive grains can be measured by the photon correlation method, and specifically, can be measured using, for example, device name: Zetasizer 3000HS manufactured by Malvern Instruments Ltd., device name: N5 manufactured by Beckman Coulter, Inc. or the like. Specifically, in a measuring method using N5, for example, an aqueous dispersion having a content of the abrasive grains adjusted to 0.2 mass % is prepared, approximately 4 mL of this aqueous dispersion is poured into a 1-cm square cell, and the cell is placed in the device. A value obtained by performing measurement at 25° C. with a refractive index and a viscosity of a dispersion medium adjusted to 1.33 and 0.887 mPa·s can be used as the average particle diameter of the abrasive grains.

[Absorbance]

In the case where the abrasive grains obtained after the above-described heating step produce absorbance of 1.00 or more for light having a wavelength of 400 nm in an aqueous dispersion having a content of the abrasive grains adjusted to 1.0 mass %, a polishing rate becomes easy to be improved, and storage stability becomes easy to be improved. The reason for this is not necessarily clear, but the present inventors conjecture as follows. Specifically, it is thought that, since particles including M(OH)ₐX_{b} generated depending on manufacturing conditions of the hydroxide of a tetravalent metal element and the like absorb light having a wavelength of 400 nm, as the abundance of M(OH)ₐX_{b} is increased and the absorbance for light having a wavelength of 400 nm is increased, the polishing rate is improved.

The absorption peak of M(OH)ₐX_{b} (for example, M(OH)₃X) at a wavelength of 400 nm has been confirmed to be much smaller than the absorption peak at a wavelength of 290 nm described below. In this regard, the present inventors studied the magnitude of absorbance using an aqueous dispersion having an abrasive grain content of 1.0 mass %, which has a relatively high abrasive grain content and whose absorbance is easily detected to a greater degree, and as a result, found that a polishing rate improving effect and storage stability tend to be excellent in the case of using abrasive grains which produce absorbance of 1.00 or more for light having a wavelength of 400 nm in such aqueous dispersion. Since the absorbance for light having a wavelength of 400 nm is thought to be derived from the abrasive grains as described above, it is indisputable that a material to be polished cannot be polished at an excellent polishing rate while maintaining storage stability with a polishing liquid comprising a substance which produces absorbance of 1.00 or more for light having a wavelength of 400 nm (for example, a pigment composition which exhibits a yellow color) in place of the abrasive grains which produce absorbance of 1.00 or more for light having a wavelength of 400 nm.

From the viewpoint of making it easier to polish a material to be polished at an excellent polishing rate, the absorbance for light having a wavelength of 400 nm is preferably 1.50 or more.

On the other hand, as mentioned above, the result showing that the structure stability of the particles of a hydroxide of a tetravalent metal element is decreased as the abundance of X is increased has been obtained. In this regard, the present inventors found that both a polishing rate and storage stability are achieved by adjusting the abundance of M(OH)ₐX_{b} using the absorbance for light having a wavelength of 400 nm as an index. The present inventors found that, by using abrasive grains which produce absorbance of 1.00 or more and less than 1.50 for light having a wavelength of 400 nm in an aqueous dispersion having a content of the abrasive grains adjusted to 1.0 mass %, excellent storage stability (for example, stability of polishing rate when storing at 60° C. for 72 hours) becomes easy to be obtained while maintaining an excellent polishing rate. According to such a viewpoint, the absorbance for light having a wavelength of 400 nm is preferably 1.05 or more, more preferably 1.10 or more, further preferably 1.15 or more, particularly preferably 1.20 or more, and extremely preferably 1.25 or more.

The present inventors found that a material to be polished can be polished at a further excellent polishing rate in the case where the abrasive grains, which produce absorbance of 1.00 or more for light having a wavelength of 400 nm, produce absorbance of 1.000 or more for light having a wavelength of 290 nm in an aqueous dispersion having a content of the abrasive grains adjusted to 0.0065 mass %.

The reason why a polishing rate improving effect is obtained by using the abrasive grains which produce absorbance of 1.000 or more for light having a wavelength of 290 nm in the aqueous dispersion having a content of the abrasive grains adjusted to 0.0065 mass % is not necessarily clear, but the present inventors conjecture as follows. Specifically, particles including M(OH)ₐX_{b} (for example, M(OH)₃X) which are generated depending on manufacturing conditions of the hydroxide of a tetravalent metal element and the like have a calculated absorption peak at a wavelength of about 290 nm, for example, particles composed of Ce⁴⁺(OH⁻)₃NO₃⁻ have an absorption peak at a wavelength of 290 nm. Thus, it is thought that, as the abundance of M(OH)ₐX_{b} is increased and the absorbance for light having a wavelength of 290 nm is increased, the polishing rate is improved.

The absorbance for light having a wavelength of about 290 nm tends to be detected to a greater degree as the measuring limit is exceeded. In this regard, the present inventors studied the magnitude of absorbance using an aqueous dispersion having an abrasive grain content of 0.0065 mass %, which has a relatively low abrasive grain content and whose absorbance is easily detected to a small degree, and as a result, found that a polishing rate improving effect is excellent in the case of using abrasive grains which produce absorbance of 1.000 or more for light having a wavelength of 290 nm in such aqueous dispersion. Moreover, the present inventors found that, apart from light having a wavelength of about 400 nm which tends to make a light-absorbing substance exhibit a yellow color when being absorbed by a light-absorbing substance, as absorbance of abrasive grains for light having a wavelength of about 290 nm becomes high, yellowishness of a polishing liquid and a slurry using such abrasive grains becomes deep, and found that the polishing rate is improved as the yellowishness of the polishing liquid and the slurry becomes deep. The present inventors found that the absorbance for light having a wavelength of 290 nm in an aqueous dispersion having an abrasive grain content of 0.0065 mass % is correlated with the absorbance for light having a wavelength of 400 nm in an aqueous dispersion having an abrasive grain content of 1.0 mass %.

The lower limit of the absorbance for light having a wavelength of 290 inn is preferably 1.000 or more, more preferably 1.050 or more, further preferably 1.100 or more, particularly preferably 1.130 or more, from the viewpoint of polishing a material to be polished at a further excellent polishing rate. The upper limit of the absorbance for light having a wavelength of 290 nm is not particularly limited, but it is preferably 10.000 or less, more preferably 5.000 or less, and further preferably 3.000 or less.

The hydroxide of a tetravalent metal element (for example, M(OH)ₐX_{b}) tends not to have light absorption for light having a wavelength of 450 nm or more, especially for light having a wavelength of 450 to 600 nm. Therefore, from the viewpoint of suppressing adverse impacts on polishing due to inclusion of impurities and polishing a material to be polished at a further excellent polishing rate, the abrasive grains preferably produce absorbance of 0.010 or less for light having a wavelength of 450 to 600 nm in an aqueous dispersion having a content of the abrasive grains adjusted to 0.0065 mass % (65 ppm). That is, absorbance for all of light within a range of a wavelength of 450 to 600 nm preferably does not exceed 0.010 in the aqueous dispersion having a content of the abrasive grains adjusted to 0.0065 mass %. The upper limit of the absorbance for light having a wavelength of 450 to 600 nm is more preferably 0.005 or less, and further preferably 0.001 or less. The lower limit of the absorbance for light having a wavelength of 450 to 600 nm is preferably 0.

The absorbance in an aqueous dispersion can be measured, for example, using a spectrophotometer (device name: U3310) manufactured by Hitachi, Ltd. Specifically, an aqueous dispersion having a content of the abrasive grains adjusted to 1.0 mass % or 0.0065 mass % is prepared as a measuring sample. Approximately 4 mL of the measuring sample is poured into a 1-cm square cell, and the cell is placed in the device. Next, absorbance measurement is performed within a range of a wavelength of 200 to 600 nm, and the absorbance is determined from the obtained chart.

If absorbance of 1.00 or more is exhibited in the case where the absorbance for light having a wavelength of 400 nm is measured by excessively diluting such that the content of the abrasive grains is less than 1.0 mass %, the absorbance may be screened by assuming that the absorbance is 1.00 or more in the case where the content of the abrasive grains is 1.0 mass %. If absorbance of 1.000 or more is exhibited in the case where the absorbance for light having a wavelength of 290 nm is measured by excessively diluting such that the content of the abrasive grains is less than 0.0065 mass %, the absorbance may be screened by assuming that the absorbance is 1.000 or more in the case where the content of the abrasive grains is 0.0065 mass %. If absorbance of 0.010 or less is exhibited in the case where the absorbance for light having a wavelength of 450 to 600 nm is measured by diluting such that the content of the abrasive grains is more than 0.0065 mass %, the absorbance may be screened by assuming that the absorbance is 0.010 or less in the case where the content of the abrasive grains is 0.0065 mass %.

[Light Transmittance]

The polishing liquid of the present embodiment preferably has high transparency for visible light (it is visually transparent or nearly transparent). Specifically, the abrasive grains comprised in the polishing liquid of the present embodiment preferably produce light transmittance of 50%/cm or more for light having a wavelength of 500 nm in an aqueous dispersion having a content of the abrasive grains adjusted to 1.0 mass %. This makes it possible to further suppress a reduction in the polishing rate due to the addition of an additive, and thus, it becomes easier to obtain other properties while maintaining the polishing rate. From this viewpoint, the lower limit of the light transmittance is more preferably 60%/cm or more, further preferably 70%/cm or more, particularly preferably 80%/cm or more, extremely preferably 90%/cm or more, very preferably 95%/cm or more, still further preferably 98%/cm or more, and further preferably 99%/cm or more. The upper limit of the light transmittance is 100%/cm.

The reason why the reduction in the polishing rate can be suppressed by adjusting the light transmittance of the abrasive grains in this manner is not understood in detail, but the present inventors conjecture as follows. The action of the abrasive grains including the hydroxide of a tetravalent metal element (such as cerium) as abrasive grains is thought to more dominantly depend on the chemical action than on the mechanical action. Therefore, the number of the abrasive grains is thought to contribute to the polishing rate more than the size of the abrasive grains.

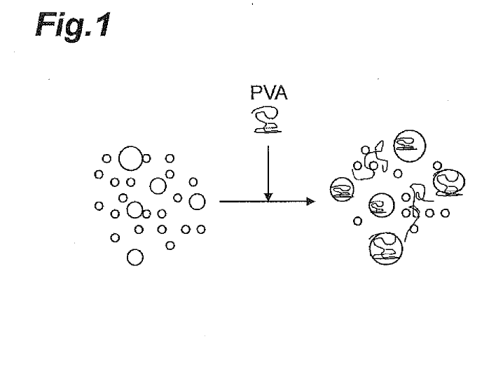

In the case where the light transmittance is low in an aqueous dispersion having a content of the abrasive grains adjusted to 1.0 mass %, it is thought that, in the abrasive grains present in the aqueous dispersion, particles having a large particle diameter (hereinafter referred to as “coarse particles”) exist in relatively large numbers. When an additive (for example, polyvinyl alcohol (PVA)) is added to a polishing liquid comprising such abrasive grains, other particles aggregate around the coarse particles as nuclei, as shown in FIG. 1. It is thought that, as a result, the number of the abrasive grains which act on a surface to be polished per unit area (effective abrasive grain number) is reduced and the specific surface area of the abrasive grains which contact the surface to be polished is reduced, and thus, the reduction in the polishing rate occurs.

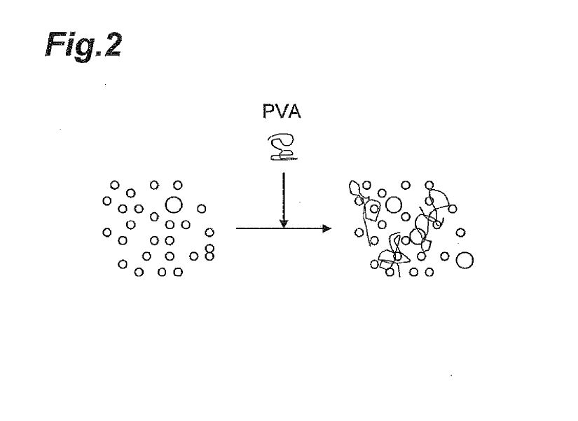

On the other hand, in the case where the light transmittance is high in an aqueous dispersion having a content of the abrasive grains adjusted to 1.0 mass %, it is thought that the abrasive grains present in the aqueous dispersion are in a state where the above-described “coarse particles” are small in number. In the case where the abundance of the coarse particles is low in this manner, even when an additive (for example, polyvinyl alcohol) is added to a polishing liquid, since the coarse particles which are to be nuclei for aggregation are small in number, aggregation between abrasive grains is suppressed or the size of aggregated particles becomes smaller compared with the aggregated particles shown in FIG. 1, as shown in FIG. 2. It is thought that, as a result, the number of the abrasive grains which act on a surface to be polished per unit area (effective abrasive grain number) is maintained and the specific surface area of the abrasive grains which contact the surface to be polished is maintained, and thus, the reduction in the polishing rate becomes difficult to occur.

According to the study by the present inventors, it was found that, even among polishing liquids in which particle diameters measured by a common particle diameter measuring device are the same, some may be visually transparent (high light transmittance) and some may be visually turbid (low light transmittance). Accordingly, it is thought that the coarse particles which can produce the action described above contribute to the reduction in the polishing rate even by a very slight amount which cannot be detected by a common particle diameter measuring device.

Moreover, it was found that, even if filtration is repeated multiple times to reduce the coarse particles, a phenomenon of reducing the polishing rate due to an additive is not significantly improved, and in some cases, the above-described polishing rate improving effect due to absorbance is not sufficiently exhibited. The present inventors found that the above-described problem can be solved by using abrasive grains having high light transmittance in an aqueous dispersion, by devising a manufacturing method of the abrasive grains or the like.

The above-described light transmittance is transmittance for light having a wavelength of 500 nm. The above-described light transmittance is measured by a spectrophotometer, and specifically, is measured by a spectrophotometer U3310 (device name) manufactured by Hitachi, Ltd., for example.

As a more specific measuring method, an aqueous dispersion having a content of the abrasive grains adjusted to 1.0 mass % is prepared as a measuring sample. Approximately 4 mL of the measuring sample is poured into a 1-cm square cell, and the cell is placed in the device and measurement is performed. In the case where the light transmittance is 50%/cm or more in an aqueous dispersion having a content of the abrasive grains of more than 1.0 mass %, it is clear that the light transmittance is also 50%/cm or more in the case where it is diluted to 1.0 mass %. Therefore, the light transmittance can be screened by a simple method by using an aqueous dispersion having a content of the abrasive grains of more than 1.0 mass %.

The above-described absorbance and light transmittance which the abrasive grains produce in the aqueous dispersion preferably excel in stability. For example, after retaining the aqueous dispersion at 60° C. for 3 days (72 hours), the absorbance for light having a wavelength of 400 nm is preferably 1.00 or more, the absorbance for light having a wavelength of 290 nm is preferably 1.00 or more, the absorbance for light having a wavelength of 450 to 600 nm is preferably 0.010 or less, and the light transmittance for light having a wavelength of 500 nm is preferably 50%/cm or more. Further preferred ranges of these absorbance and light transmittance are the same as the above-described ranges of the abrasive grains.

The absorbance and light transmittance which the abrasive grains comprised in the polishing liquid produce in the aqueous dispersion can be measured by, after removing solid components other than the abrasive grains and liquid components other than water, preparing an aqueous dispersion having a predetermined abrasive grain content and using the aqueous dispersion. For removing the solid components and the liquid components, although varying depending on components comprised in the polishing liquid, centrifugation methods such as centrifugation using a centrifuge capable of applying gravitational acceleration of several thousand G or less and ultracentrifugation using an ultracentrifuge capable of applying gravitational acceleration of several tens of thousands G or more; chromatography methods such as partition chromatography, adsorption chromatography, gel permeation chromatography, and ion-exchange chromatography; filtration methods such as natural filtration, filtration under reduced pressure, pressure filtration, and ultrafiltration; distillation methods such as distillation under reduced pressure and atmospheric distillation, and the like, can be used, or these may be combined as appropriate.

For example, in the case of including a compound having a weight-average molecular weight of several tens of thousands or more (for example, 50000 or more), there are chromatography methods, filtration methods and the like, and among them, gel permeation chromatography and ultrafiltration are preferable. In the case of using filtration methods, the abrasive grains comprised in the polishing liquid can be made to pass through a filter by setting appropriate conditions. In the case of including a compound having a weight-average molecular weight of several tens of thousands or less (for example, less than 50000), there are chromatography methods, filtration methods, distillation methods and the like, and gel permeation chromatography, ultrafiltration, and distillation under reduced pressure are preferable. In the case of including other kinds of abrasive grains, there are filtration methods, centrifugation methods and the like, and much abrasive grains including the hydroxide of a tetravalent metal element are comprised in a filtrate in the case of filtration and in a liquid phase in the case of centrifugation.

As a method for separating the abrasive grains by chromatography methods, for example, the abrasive grain component can be fractionated and/or other components can be fractionated by the following conditions.

sample solution: polishing liquid 100 μL

detector: UV-VIS Detector manufactured by Hitachi, Ltd., product name “L-4200”, wavelength: 400 nm

integrator: GPC Integrator manufactured by Hitachi, Ltd., product name “D-2500”

pump: manufactured by Hitachi, Ltd., product name “L-7100”

column: packing column for water-based HPLC manufactured by Hitachi Chemical Co., Ltd., product name “GL-W550S”

eluent: deionized water

measurement temperature: 23° C.

flow rate: 1 mL/min (pressure is about 40 to 50 kg/cm²)

measurement time: 60 min

It is to be noted that deaeration treatment of an eluent is preferably performed using a deaerator before performing chromatography. In the case where a deaerator cannot be used, an eluent is preferably deaeration-treated in advance with ultrasonic wave or the like.

The abrasive grain component may not be able to be fractionated under the above-described conditions depending on components comprised in the polishing liquid, and in this case, it can be separated by optimizing the amount of a sample solution, the kind of a column, the kind of an eluent, a measurement temperature, a flow rate and the like. Moreover, by adjusting the pH of the polishing liquid, distillation time of the components comprised in the polishing liquid is adjusted, and it may be separated from the abrasive grains. In the case where the polishing liquid comprises insoluble components, the insoluble components are preferably removed by filtration, centrifugation or the like, as necessary.

(Additive)

The polishing liquid of the present embodiment can obtain an especially excellent polishing rate for an insulating material (for example, silicon oxide), and thus, is especially suitable for use in polishing a base substrate having an insulating material. According to the polishing liquid of the present embodiment, by selecting an additive as appropriate, both a polishing rate and polishing properties other than the polishing rate can be achieved at a high level.

As the additive, for example, known additives such as a dispersing agent which increases dispersibility of the abrasive grains, a polishing rate improver which improves the polishing rate, a flattening agent (a flattening agent which reduces irregularities on a surface to be polished after polishing, a global flattening agent which improves global flatness of a base substrate after polishing), and a selection ratio improver which improves a polishing selection ratio of an insulating material with respect to a stopper material such as silicon nitride or polysilicon can be used without particular limitation.

Examples of the dispersing agent include vinyl alcohol polymers and derivatives thereof, betaine, lauryl betaine, and lauryl dimethylamine oxide. Examples of the polishing rate improver include β-alanine betaine and stearyl betaine. Examples of the flattening agent which reduces irregularities on a surface to be polished include ammonium lauryl sulfate and triethanolamine polyoxyethylene alkyl ether sulfate. Examples of the global flattening agent include polyvinylpyrrolidone and polyacrolein. Examples of the selection ratio improver include polyethyleneimine, polyallylamine, and chitosan. These can be used singly or in combinations of two or more.

The polishing liquid of the present embodiment preferably comprises at least one selected from the group consisting of vinyl alcohol polymers and derivatives thereof as the additive. In this case, the additive covers the surface of the abrasive grains, and thus, adhesion of the abrasive grains to the surface to be polished is suppressed, and therefore, dispersibility of the abrasive grains is improved and stability of the abrasive grains can be further improved. Moreover, washability of the surface to be polished can also be improved. However, generally, vinyl alcohol which is a monomer of polyvinyl alcohol tends not to exist alone as a stable compound. Therefore, polyvinyl alcohol is generally obtained by polymerizing a vinyl carboxylate monomer such as a vinyl acetate monomer to obtain poly(vinyl carboxylate) and saponifying (hydrolyzing) this. Therefore, for example, a vinyl alcohol polymer obtained using a vinyl acetate monomer as a raw material includes —OCOCH₃ and hydrolyzed —OH as functional groups in the molecule, and the ratio of —OH is defined as a saponification degree. That is, a vinyl alcohol polymer whose saponification degree is not 100% has a structure which is essentially a copolymer of vinyl acetate and vinyl alcohol. Moreover, a vinyl alcohol polymer may be one obtained by copolymerizing a vinyl carboxylate monomer such as a vinyl acetate monomer and other vinyl group-containing monomer (for example, ethylene, propylene, styrene, and vinyl chloride) and saponifying all or a part of portions derived from the vinyl carboxylate monomer. In the present description, all of these are correctively referred to as “vinyl alcohol polymers”, and a “vinyl alcohol polymer” is ideally a polymer having the following structural formula.

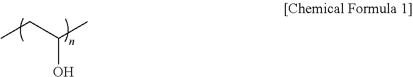

(wherein n represents a positive integer)

A “derivative” of a vinyl alcohol polymer is defined to include a derivative of a homopolymer of vinyl alcohol (that is, polymer having a saponification degree of 100%) and derivatives of copolymers of a vinyl alcohol monomer and other vinyl group-containing monomers (for example, ethylene, propylene, styrene, vinyl chloride).

Examples of the derivative of a vinyl alcohol polymer include polymers in which a part of hydroxyl groups is substituted by amino groups, carboxyl groups, ester groups or the like, and polymers in which a part of hydroxyl groups is modified. Examples of such a derivative include reactive polyvinyl alcohols (for example, GOHSEFIMER (registered trademark) Z manufactured by Nippon Synthetic Chemical Industry Co., Ltd.), cationized polyvinyl alcohols (for example, GOHSEFIMER (registered trademark) K manufactured by Nippon Synthetic Chemical Industry Co., Ltd.), anionized polyvinyl alcohols (for example, GOHSERAN (registered trademark) L and GOHSENOL (registered trademark) T manufactured by Nippon Synthetic Chemical Industry Co., Ltd.), and hydrophilic group-modified polyvinyl alcohols (for example, ECOMATI manufactured by Nippon Synthetic Chemical Industry Co., Ltd.).

As described above, a vinyl alcohol polymer and a derivative thereof function as a dispersing agent of the abrasive grains, and have an effect of further improving stability of the polishing liquid. It is thought that interaction between hydroxyl groups of the vinyl alcohol polymer and a derivative thereof and the abrasive grains including the hydroxide of a tetravalent metal element suppresses aggregation of the abrasive grains and suppresses a change in the particle diameter of the abrasive grains in the polishing liquid, and thus, stability can be further improved.

By using the vinyl alcohol polymer and a derivative thereof in combination with the abrasive grains including the hydroxide of a tetravalent metal element, the polishing selection ratio of an insulating material (for example, silicon oxide) with respect to a stopper material (for example, silicon nitride, polysilicon), (polishing rate of insulating material/polishing rate of stopper material), can also be increased. Moreover, the vinyl alcohol polymer and a derivative thereof can improve flatness of a surface to be polished after polishing, and can also prevent adhesion of the abrasive grains to the surface to be polished (improvement in washability).

From the viewpoint of further increasing a polishing selection ratio of an insulating material with respect to a stopper material, the saponification degree of the vinyl alcohol polymer and a derivative thereof is preferably 95 mol % or less. From the same viewpoint, the upper limit of the saponification degree is more preferably 90 mol % or less, further preferably 88 mol % or less, particularly preferably 85 mol % or less, extremely preferably 83 mol % or less, and very preferably 80 mol % or less.

The lower limit of the saponification degree is not particularly limited, but from the viewpoint of excelling in solubility in water, it is preferably 50 mol % or more, more preferably 60 mol % or more, and further preferably 70 mol % or more. It is to be noted that the saponification degree of the vinyl alcohol polymer and a derivative thereof can be measured in conformity with JIS K 6726 (Testing methods for polyvinyl alcohol).

The upper limit of the average degree of polymerization (weight-average molecular weight) of the vinyl alcohol polymer and a derivative thereof is not particularly limited, but from the viewpoint of further suppressing a reduction in the polishing rate of a material to be polished, it is preferably 3000 or less, more preferably 2000 or less, and further preferably 1000 or less.

From the viewpoint of further increasing a polishing selection ratio of an insulating material with respect to a stopper material, the lower limit of the average degree of polymerization is preferably 50 or more, more preferably 100 or more, and further preferably 150 or more. It is to be noted that the average degree of polymerization of the vinyl alcohol polymer and a derivative thereof can be measured in conformity with JIS K 6726 (Testing methods for polyvinyl alcohol).

For the purpose of adjusting a polishing selection ratio of an insulating material with respect to a stopper material and flatness of a base substrate after polishing, multiple polymers having different saponification degrees, average degrees of polymerization or the like may be used in combination as the vinyl alcohol polymer and a derivative thereof. In this case, the saponification degree of at least one vinyl alcohol polymer and a derivative thereof is preferably 95 mol % or less, and from the viewpoint of further improving a polishing selection ratio, the average saponification degree calculated from each saponification degree and the mixing ratio is more preferably 95 mol % or less. The preferred range of these saponification degrees is the same as the above-described range.

From the viewpoint of more effectively obtaining effects of an additive, the content of the additive is preferably 0.01 mass % or more, more preferably 0.05 mass % or more, further preferably 0.08 mass % or more, and particularly preferably 0.1 mass % or more, based on the total mass of the polishing liquid. From the viewpoint of further suppressing a reduction in the polishing rate of a material to be polished, the content of the additive is preferably 10 mass % or less, more preferably 5.0 mass % or less, further preferably 3.0 mass % or less, and particularly preferably 1.0 mass % or less, based on the total mass of the polishing liquid.

(Water)

Water in the polishing liquid of the present embodiment is not particularly limited, but deionized water, ultrapure water or the like is preferable. The content of water may be the remainder of the polishing liquid excluding the contents of other constituent components, and is not particularly limited.

A method for dispersing the abrasive grains into water is not particularly limited, and specific examples thereof include a dispersing method by stirring; and a dispersing method with a homogenizer, an ultrasonic disperser, a wet ball mill or the like.

[Properties of Polishing Liquid]

The pH (25° C.) of the polishing liquid is preferably 2.0 to 9.0 from the viewpoint of obtaining a further excellent polishing rate. It is thought that this is because the surface potential of the abrasive grains with respect to the surface potential of a surface to be polished becomes favorable, and the abrasive grains become easy to act on the surface to be polished. From the viewpoint of stabilizing the pH of the polishing liquid and making it difficult for problems such as aggregation of the abrasive grains to occur, the lower limit of the pH is preferably 2.0 or more, more preferably 3.0 or more, and further preferably 4.0 or more. From the viewpoint of excelling in dispersibility of the abrasive grains and obtaining a further excellent polishing rate, the upper limit of the pH is preferably 9.0 or less, more preferably 8.0 or less, and further preferably 7.5 or less. The pH of the polishing liquid can be measured by the same method as the above-described pH of the mixed liquid.

In order to adjust the pH of the polishing liquid, a conventionally-known pH adjuster can be used without particular limitation. Specific examples of the pH adjuster include inorganic acids such as phosphoric acid, sulfuric acid, and nitric acid; organic acids such as carboxylic acids such as formic acid, acetic acid, propionic acid, maleic acid, phthalic acid, citric acid, succinic acid, malonic acid, glutaric acid, adipic acid, fumaric acid, lactic acid, and benzoic acid; amines such as ethylenediamine, toluidine, piperazine, histidine, aniline, 2-aminopyridine, 3-aminopyridine, picoline acid, morpholine, piperidine, and hydroxylamine; and nitrogen-containing heterocyclic compounds such as pyridine, imidazole, triazole, pyrazole, benzimidazole, and benzotriazole. It is to be noted that the pH adjuster may be comprised in a slurry (including slurry precursor, storage liquid for slurry and the like), an additive liquid and the like described below.

A pH stabilizer means an additive for adjustment to a predetermined pH, and it is preferably a buffer component. The buffer component is preferably a compound having pKa within a range of ±1.5, and more preferably a compound having pKa within a range of ±1.0, with respect to the predetermined pH. Examples of such a compound include amino acids such as glycine, arginine, lysine, asparagine, aspartic acid, and glutamic acid; mixtures of the above-described carboxylic acids and bases; and salts of the above-described carboxylic acids.

<Slurry>

The slurry of the present embodiment may be used directly for polishing, or may be used as a slurry of a so-called two-pack type polishing liquid, in which the constituent components of the polishing liquid are separated into a slurry and an additive liquid. In the present embodiment, the polishing liquid and the slurry differ in the presence or absence of an additive, and the polishing liquid is obtained by adding the additive to the slurry.

The slurry of the present embodiment comprises at least the same abrasive grains as the polishing liquid of the present embodiment, and water. For example, the abrasive grains are characterized by including the hydroxide of a tetravalent metal element, and a preferred range and a measuring method of the average secondary particle diameter of the abrasive grains are the same as the abrasive grains used in the polishing liquid of the present embodiment.

In the constituent components of the slurry of the present embodiment, the hydroxide of a tetravalent metal element is thought to have a significant impact on polishing properties. Thus, by adjusting the content of the hydroxide of a tetravalent metal element, a chemical interaction between the abrasive grains and a surface to be polished is improved, and the polishing rate can be further improved. Specifically, the content of the hydroxide of a tetravalent metal element is preferably 0.01 mass % or more, more preferably 0.03 mass % or more, and further preferably 0.05 mass % or more, based on the total mass of the slurry, from the viewpoint of making it easier to sufficiently exhibit the function of the hydroxide of a tetravalent metal element. The content of the hydroxide of a tetravalent metal element is preferably 8 mass % or less, more preferably 5 mass % or less, further preferably 3 mass % or less, particularly preferably 1 mass % or less, extremely preferably 0.7 mass % or less, and very preferably 0.5 mass % or less, based on the total mass of the slurry, from the viewpoint of making it easier to avoid aggregation of the abrasive grains, and from the viewpoint of obtaining a favorable chemical interaction with the surface to be polished, and capable of effectively using properties of the abrasive grains (for example, polishing rate improving action).

In the slurry of the present embodiment, the lower limit of the content of the abrasive grains is preferably 0.01 mass % or more, more preferably 0.03 mass % or more, and further preferably 0.05 mass % or more, based on the total mass of the slurry, from the viewpoint of making it easier to obtain an intended polishing rate. The upper limit of the content of the abrasive grains is not particularly limited, but from the viewpoint of making it easier to avoid aggregation of the abrasive grains, it is preferably 10 mass % or less, more preferably 5 mass % or less, further preferably 3 mass % or less, particularly preferably 1 mass % or less, extremely preferably 0.7 mass % or less, and very preferably 0.5 mass % or less, based on the total mass of the slurry.

The pH (25° C.) of the slurry of the present embodiment is preferably 2.0 to 9.0 from the viewpoint of obtaining a further excellent polishing rate because the surface potential of the abrasive grains with respect to the surface potential of a surface to be polished becomes favorable, and the abrasive grains become easy to act on the surface to be polished. From the viewpoint of stabilizing the pH of the slurry and making it difficult for problems such as aggregation of the abrasive grains to occur, the lower limit of the pH is preferably 2.0 or more, more preferably 2.2 or more, and further preferably 2.5 or more. From the viewpoint of excelling in dispersibility of the abrasive grains and obtaining a further excellent polishing rate, the upper limit of the pH is preferably 9.0 or less, more preferably 8.0 or less, further preferably 7.0 or less, particularly preferably 6.5 or less, and extremely preferably 6.0 or less. The pH of the slurry can be measured by the same method as the pH of the above-described mixed liquid.

<Polishing-Liquid Set>

In the polishing-liquid set of the present embodiment, the constituent components of the polishing liquid are separately stored as a slurry and an additive liquid such that the slurry (first liquid) and the additive liquid (second liquid) are mixed to form the polishing liquid. As the slurry, the slurry of the present embodiment can be used. As the additive liquid, a liquid in which the additive is dissolved in water (liquid comprising additive and water) can be used. The polishing-liquid set is used as a polishing liquid by mixing the slurry and the additive liquid when polishing. By separately storing the constituent components of the polishing liquid into at least two liquids in this manner, problems such as aggregation of the abrasive grains and a change in polishing properties, which are concerned in the case of storing for a long time after mixing the additive, can be avoided, and a polishing liquid which further excels in storage stability can be obtained. It is to be noted that, in the polishing-liquid set of the present embodiment, the constituent components may be separated into three liquids or more.

As the additive comprised in the additive liquid, the same additive as one described for the above-described polishing liquid can be used. From the viewpoint of suppressing an excessive reduction in the polishing rate when the additive liquid and the slurry are mixed to prepare the polishing liquid, the content of the additive in the additive liquid is preferably 0.01 mass % or more, and more preferably 0.02 mass % or more, based on the total mass of the additive liquid. From the viewpoint of suppressing an excessive reduction in the polishing rate when the additive liquid and the slurry are mixed to prepare the polishing liquid, the content of the additive in the additive liquid is preferably 20 mass % or less based on the total mass of the additive liquid.

Water in the additive liquid is not particularly limited, but deionized water, ultrapure water or the like is preferable. The content of water may be the remainder excluding the contents of other constituent components, and is not particularly limited.

<Base Substrate Polishing Method and Base Substrate>

A base substrate polishing method using the above-described polishing liquid, slurry or polishing-liquid set, and a base substrate obtained thereby will be described. The polishing method of the present embodiment is a polishing method using a one-pack type polishing liquid in the case of using the above-described polishing liquid or slurry, and is a polishing method using a two-pack type polishing liquid or a three-pack or more type polishing liquid in the case of using the above-described polishing-liquid set. According to these polishing methods, a material to be polished can be polished at an excellent polishing rate. Moreover, according to these polishing methods, generation of polishing scratch can be suppressed, and a base substrate which excels in flatness can also be obtained. The base substrate of the present embodiment is polished by the above-described polishing methods.

In the base substrate polishing method of the present embodiment, a base substrate having a material to be polished on the surface (for example, substrate such as semiconductor substrate) is polished. In the base substrate polishing method of the present embodiment, the material to be polished may be polished using a stopper formed under the material to be polished. The base substrate polishing method of the present embodiment comprises at least a preparing step, a base substrate arranging step and a polishing step, for example. In the preparing step, a base substrate having a material to be polished on the surface is prepared. In the base substrate arranging step, the base substrate is arranged such that the material to be polished is arranged to be opposed to a polishing pad. In the polishing step, at least a part of the material to be polished is removed by using the polishing liquid, slurry or polishing-liquid set. The shape of the material to be polished, which is subjected to be polished, is not particularly limited, and it is a film shape (material film to be polished), for example.

Examples of the material to be polished include inorganic insulating materials such as silicon oxide; organic insulating materials such as organosilicate glass and a wholly aromatic ring based Low-k material; and stopper materials such as silicon nitride and polysilicon, and among them, inorganic insulating materials and organic insulating materials are preferable, and inorganic insulating materials are more preferable. A silicon oxide film can be obtained by a low-pressure CVD method, a plasma CVD method or the like. The silicon oxide film may be doped with an element such as phosphorus and boron. Irregularities are preferably formed on the surface of the material to be polished (surface to be polished). In the base substrate polishing method of the present embodiment, convex parts of the irregularities of the material to be polished are preferentially polished, and a base substrate having a flattened surface can be obtained.

In the case where the one-pack type polishing liquid or slurry is used, in the polishing step, the polishing liquid or slurry is supplied between the material to be polished of the base substrate and the polishing pad of a polishing platen, and at least a part of the material to be polished is polished. For example, the polishing liquid or slurry is supplied between the polishing pad and the material to be polished with the material to be polished pressed against the polishing pad, and at least a part of the material to be polished is polished by relatively moving the base substrate and the polishing platen. At this time, the polishing liquid and slurry may be directly supplied onto the polishing pad as a composition having an intended water amount.

From the viewpoint of reducing cost for preservation, transport, storage and the like, the polishing liquid and slurry of the present embodiment can be stored as a storage liquid for a polishing liquid or a storage liquid for a slurry, which is used by diluting liquid components 2-fold or more (based on mass), for example, with a fluid medium such as water. The above-described each storage liquid may be diluted with the fluid medium immediately before polishing, or the storage liquid and the fluid medium are supplied onto the polishing pad and diluted on the polishing pad.

The lower limit of the dilution ratio (based on mass) of the storage liquid is preferably 2-fold or more, more preferably 3-fold or more, further preferably 5-fold or more, and particularly preferably 10-fold or more because a higher ratio results in a higher reducing effect of cost for preservation, transport, storage and the like. The upper limit of the dilution ratio is not particularly limited, but a higher ratio results in a greater amount (higher concentration) of components comprised in the storage liquid and stability during storage tends to be decreased, and thus, it is preferably 500-fold or less, more preferably 200-fold or less, further preferably 100-fold or less, and particularly preferably 50-fold or less. It is to be noted that the same is applied for a polishing liquid in which the constituent components are separated into three liquids or more.

In the above-described storage liquid, the content of the abrasive grains is not particularly limited, but from the viewpoint of making it easier to avoid aggregation of the abrasive grains, it is preferably 20 mass % or less, more preferably 15 mass % or less, further preferably 10 mass % or less, and particularly preferably 5 mass % or less, based on the total mass of the storage liquid. From the viewpoint of reducing cost for preservation, transport, storage and the like, the content of the abrasive grains is preferably 0.02 mass % or more, more preferably 0.1 mass % or more, further preferably 0.5 mass % or more, and particularly preferably 1 mass % or more, based on the total mass of the storage liquid.

In the case where the two-pack type polishing liquid is used, the base substrate polishing method of the present embodiment may comprise a polishing liquid preparing step in which the slurry and the additive liquid are mixed before the polishing step to obtain a polishing liquid. In this case, in the polishing step, the material to be polished is polished using the polishing liquid obtained in the polishing liquid preparing step. In the polishing liquid preparing step of the foregoing polishing method, the slurry and the additive liquid are solution-sent through separate pipes, and these pipes are merged just before the exit of a supply pipe to obtain the polishing liquid. The polishing liquid may be directly supplied onto the polishing pad as a polishing liquid having an intended water amount, or may be diluted on the polishing pad after being supplied onto the polishing pad as a storage liquid having a small water amount. It is to be noted that the same is applied for a polishing liquid in which the constituent components are separated into three liquids or more.

In the case where the two-pack type polishing liquid is used, in the polishing step, at least a part of the material to be polished may be polished by the polishing liquid obtained by supplying each of the slurry and the additive liquid between the polishing pad and the material to be polished to mix the slurry and the additive liquid. In the foregoing polishing method, the slurry and the additive liquid can be supplied onto the polishing pad through separate solution-sending systems. The slurry and/or the additive liquid may be directly supplied onto the polishing pad as a liquid having an intended water amount, or may be diluted on the polishing pad after being supplied onto the polishing pad as a storage liquid having a small water amount. It is to be noted that the same is applied for a polishing liquid in which the constituent components are separated into three liquids or more.

As a polishing device used in the polishing method of the present embodiment, for example, a common polishing device having a holder for holding a base substrate having a material to be polished, and a polishing platen fitted with a motor capable of changing a rotational frequency and the like, and capable of being fitted with a polishing pad, can be used. Examples of the polishing device include a polishing device (model number: EPO-111) manufactured by EBARA CORPORATION, and a polishing device (product name: Mirra3400, Reflexion Polishing Machine) manufactured by Applied Materials, Inc.

The polishing pad is not particularly limited, and for example, common non-woven fabric, foamed polyurethane, porous fluorine resin and the like can be used. The polishing pad subjected to groove processing such that the polishing liquid or the like accumulates therein is preferable.

The polishing conditions are not particularly limited, but from the viewpoint of suppressing flying-off of the base substrate, the rotational speed of the polishing platen is preferably a low rotation of 200 min⁻¹ (rpm) or less. The pressure (machining load) applied to the base substrate is preferably 100 kPa or less, from the viewpoint of further suppressing generation of polishing scratch. The polishing liquid, the slurry or the like is preferably continuously supplied to the surface of the polishing pad with a pump or the like during polishing. The amount supplied is not particularly limited, but the surface of the polishing pad is preferably covered with the polishing liquid, the slurry or the like at all times. It is preferable that the base substrate after the completion of polishing be washed well in running water, and then dried after removing water droplets adhering to the base substrate with a spin dryer or the like.

### EXAMPLES

Hereinafter, the present invention will be described in detail with reference to Examples, but the present invention is not limited thereto.

### Examples 1 to 5, Comparative Examples 1 to 4

### Preparation of Abrasive Grains Including Particles of Hydroxide of Tetravalent Metal Element

Abrasive grains including particles of a hydroxide of a tetravalent metal element were prepared in accordance with the following procedure. It is to be noted that the values represented by the symbols A to J in the explanation below are values shown in Table 1, respectively.

A [L] of water was charged in a container, and B [L] of cerium ammonium nitrate aqueous solution having a concentration of 50 mass % (formula Ce(NH₄)₂(NO₃)₆, formula weight 548.2 g/mol, manufactured by NIHON KAGAKU SANGYO CO., LTD., product name 50% CAN liquid) was added and mixed. After that, the liquid temperature was adjusted to C [° C.] to obtain a metal salt aqueous solution. The metal salt concentration of the metal salt aqueous solution was as shown in Table 1.

Next, an alkali species shown in Table 1 was dissolved in water to prepare E [L] of an aqueous solution having a concentration of D [mol/L], and then, the liquid temperature was adjusted to a temperature of C [° C.] to obtain an alkali liquid.

The container containing the above-described metal salt aqueous solution therein was placed in a water tank filled with water. The water temperature of the water tank was adjusted to the temperature C [° C.] using an external-circulating device Coolnics Circulator (manufactured by Tokyo Rikakikai Co., Ltd. (EYELA), product name Cooling Thermopump CTP101). The above-described alkali liquid was added into the container at a mixing rate of G [m³/min] while maintaining the temperature of the metal salt aqueous solution at C [° C.] and stirring the metal salt aqueous solution at a rotational frequency F [min⁻¹] with a stirring blade, and mixing was performed under conditions of a linear speed of H [m/min], a circulation count I [min⁻¹] and a replacement count J [min⁻¹]. After that, heating treatment was performed at a heating temperature [° C.] and heating time [hr] shown in Table 1 for the mixed liquid of the metal salt aqueous solution and the alkali liquid to obtain a slurry precursor 1 comprising abrasive grains including particles of a hydroxide of tetravalent cerium. It is to be noted that the area of the stirring blade, the rotational radius of the stirring blade, the rotational frequency of the stirring blade and the like were as shown in Table 1. The pH of the slurry precursor 1 was as indicated by “final pH” in Table 1, and the variation in pH per unit time, ΔpH, was as shown in Table 1. It is to be noted that, for ΔpH, the average value of a variation in pH per minute from the start of mixing the metal salt aqueous solution and the alkali liquid until the pH of the mixed liquid reaches the “final pH” was used. In addition, the parameter Z was as shown in Table 1.

The slurry precursor 1 was centrifuged at 3000 G and subjected to solid-liquid separation by decantation to remove the liquid. Operation in which a proper amount of water is added to the obtained residue to be stirred well, and then, centrifugation and solid-liquid separation by decantation are performed, was further performed 3 times.

Water was again added to the obtained residue to adjust the liquid amount to 1.0 L, and then, ultrasonic dispersion treatment was performed for 180 minutes to obtain a slurry precursor 2. The content of a non-volatile component (the content of the abrasive grains including a hydroxide of tetravalent cerium) of the slurry precursor 2 was calculated by taking a proper amount of the obtained slurry precursor 2 and measuring the mass before and after drying.

TABLE 1

| | Metal Salt Solution | | | | | | | | | | | |
|---|---|---|---|---|---|---|---|---|---|---|---|---|
| | | 50 mass | | | | | | | | | | |
| | | % Metal | | Alkali Liquid | | | | Manufacturing Parameters | | | | |
| | | Salt | | | Concen- | | Total | Synthesis | | | | |
| | Water | Liquid | Concen- | | tration | Liquid | Liquid | Tem- | Rotational | | Linear | Area of |
| | Amount | Amount | tration | | C_{b} | Amount | Amount | perature | Frequency | Mixing | Speed u | Stirring |
| | Q_{w} | Qₐ | Cₐ | Alkali | D[mol/ | Q_{b} | Q | T | R | Rate v | H[m/ | Blade S |
| | A[L] | B[L] | [mol/L] | Species | L] | E[L] | [m³] | C[° C.] | F[min⁻¹] | G[m³/min] | min] | [m²] |
| Example 1 | 1.840 | 0.053 | 0.037 | Ammonia | 8.8 | 0.029 | 0.0019 | 20 | 500 | 0.0000050 | 78.50 | 0.0005 |
| Example 2 | 1.656 | 0.048 | 0.037 | Imidazole | 1.5 | 0.152 | 0.0019 | 20 | 500 | 0.0000100 | 78.50 | 0.0005 |
| Example 3 | 1.656 | 0.048 | 0.037 | Imidazole | 1.5 | 0.152 | 0.0019 | 20 | 500 | 0.0000100 | 78.50 | 0.0005 |
| Example 4 | 1.656 | 0.048 | 0.037 | Imidazole | 1.5 | 0.152 | 0.0019 | 20 | 500 | 0.0000100 | 78.50 | 0.0005 |
| Example 5 | 1.656 | 0.048 | 0.037 | Imidazole | 1.5 | 0.152 | 0.0019 | 20 | 500 | 0.0000100 | 78.50 | 0.0005 |
| Comparative | 1.656 | 0.048 | 0.037 | Imidazole | 1.5 | 0.152 | 0.0019 | 20 | 400 | 0.0000100 | 100.48 | 0.0005 |
| Example 1 | | | | | | | | | | | | |
| Comparative | 1.656 | 0.048 | 0.037 | Ammonia | 8.8 | 0.026 | 0.0017 | 20 | 400 | 0.0000013 | 100.48 | 0.0020 |
| Example 2 | | | | | | | | | | | | |
| Comparative | 1.656 | 0.048 | 0.037 | Ammonia | 14.7 | 0.016 | 0.0017 | 20 | 400 | 0.0001560 | 100.48 | 0.0020 |
| Example 3 | | | | | | | | | | | | |
| Comparative | 1.656 | 0.048 | 0.037 | Imidazole | 1.5 | 0.157 | 0.0019 | 25 | 500 | 0.0000100 | 78.50 | 0.0005 |
| Example 4 | | | | | | | | | | | | |
| | | Manufacturing Parameters | | | | | | | | | Heating Treatment | |
| | | Ro- | Crystal- | | ΔpH | | Temperature | Cir- | Re- | | Heating | |
| | | tational | lization | Total | per | Final | Coefficient | culation | placement | Pa- | Tem- | Heating |
| | | Radius r | Time | ΔpH | Minute | pH | k | Count N | Count M | rameter | perature | Time |
| | | [m] | [min] | [−] | [−] | [−] | [−] | I[min⁻¹] | J[min⁻¹] | Z | [° C.] | [hr] |
| | Example 1 | 0.025 | 5.8 | 4.0 | 0.690 | 5.2 | 1.0 | 19.60 | 0.00260 | 10.93 | 60 | 18 |
| | Example 2 | 0.025 | 15.2 | 4.0 | 0.263 | 5.2 | 1.0 | 20.31 | 0.00539 | 14.32 | 60 | 9 |
| | Example 3 | 0.025 | 15.2 | 4.0 | 0.263 | 5.2 | 1.0 | 20.31 | 0.00539 | 14.32 | 60 | 24 |
| | Example 4 | 0.025 | 15.2 | 4.0 | 0.263 | 5.2 | 1.0 | 20.31 | 0.00539 | 14.32 | 60 | 72 |
| | Example 5 | 0.025 | 15.2 | 4.0 | 0.263 | 5.2 | 1.0 | 20.31 | 0.00539 | 14.32 | 80 | 6 |

| | | | | | | | | | | |
|---|---|---|---|---|---|---|---|---|---|---|
| Com- | 0.040 | 15.2 | 4.0 | 0.263 | 5.2 | 1.0 | 101.51 | 0.00539 | 71.59 | None |
| parative | | | | | | | | | | |
| Example 1 | | | | | | | | | | |
| Com- | 0.040 | 20.0 | 4.0 | 0.200 | 5.2 | 1.0 | 116.16 | 0.00075 | 772.90 | None |
| parative | | | | | | | | | | |
| Example 2 | | | | | | | | | | |
| Com- | 0.040 | 0.1 | 4.0 | 40.000 | 5.2 | 1.0 | 116.86 | 0.09071 | 0.03 | None |
| parative | | | | | | | | | | |
| Example 3 | | | | | | | | | | |
| Com- | 0.025 | 15.7 | 4.0 | 0.255 | 5.2 | 1.4 | 20.25 | 0.00537 | 10.49 | None |
| parative | | | | | | | | | | |
| Example 4 | | | | | | | | | | |

(Structure Analysis of Abrasive Grains)

A proper amount of the slurry precursor 2 was taken and vacuum dried to isolate abrasive grains. With respect to a sample obtained by being washed well with pure water, measurement by the FT-IR ATR method was performed, and a peak based on a nitrate ion (NO₃⁻) was observed in addition to a peak based on a hydroxide ion. Moreover, with respect to the same sample, measurement of XPS for nitrogen (NAPS) was performed, and a peak based on NH₄⁺ was not observed and a peak based on a nitrate ion was observed. According to these results, it was confirmed that the abrasive grains comprised in the slurry precursor 2 include at least a part of particles having a nitrate ion bonded to the cerium element. Moreover, since the abrasive grains include at least a part of particles having a hydroxide ion bonded to the cerium element, it was confirmed that the abrasive grains include a hydroxide of cerium. According to these results, it was confirmed that the hydroxide of cerium includes the hydroxide ion bonded to the cerium element.

(Measurement of Absorbance and Light Transmittance)

A proper amount of the slurry precursor 2 was taken and diluted with water such that the abrasive grain content is 0.0065 mass % (65 ppm) to obtain a measuring sample (aqueous dispersion). Approximately 4 mL of the measuring sample was poured into a 1-cm square cell, and the cell was placed in a spectrophotometer (device name: U3310) manufactured by Hitachi, Ltd. Absorbance measurement was performed within a range of a wavelength of 200 to 600 nm, and the absorbance for light having a wavelength of 290 nm and the absorbance for light having a wavelength of 450 to 600 nm were measured. The results are shown in Table 2.

A proper amount of the slurry precursor 2 was taken and diluted with water such that the abrasive grain content is 1.0 mass % to obtain a measuring sample (aqueous dispersion). Approximately 4 mL of the measuring sample was poured into a 1-cm square cell, and the cell was placed in a spectrophotometer (device name: U3310) manufactured by Hitachi, Ltd. Absorbance measurement was performed within a range of a wavelength of 200 to 600 nm, and the absorbance for light having a wavelength of 400 nm and the light transmittance for light having a wavelength of 500 nm were measured. The results are shown in Table 2.

(Measurement of Average Secondary Particle Diameter)

A proper amount of the slurry precursor 2 was taken and diluted with water such that the abrasive grain content is 0.2 mass % to obtain a measuring sample (aqueous dispersion). Approximately 4 mL of the measuring sample was poured into a 1-cm square cell, and the cell was placed in N5: device name, manufactured by Beckman Coulter, Inc. Measurement was performed at 25° C. with a refractive index and a viscosity of a dispersion medium adjusted to 1.33 and 0.887 mPa·s, and the indicated average particle diameter value was used as the average secondary particle diameter. The results are shown in Table 2.

TABLE 2

| | | | | Light | |
|---|---|---|---|---|---|
| | | | | Transmittance | Average |
| | Absorbance | Absorbance | Absorbance | [500 nm] | Secondary |
| | [290 nm] | [450-600 nm] | [400 nm] | [%/cm] | Particle |
| | Abrasive Grain Content: | | Abrasive Grain Content: | | Diameter |
| | 65 ppm | | 1.0 mass % | | [nm] |
| Example 1 | 1.105 | <0.010 | 1.38 | >99 | 43 |
| Example 2 | 1.145 | <0.010 | 1.50 | >99 | 12 |
| Example 3 | 1.135 | <0.010 | 1.49 | >99 | 13 |
| Example 4 | 1.131 | <0.010 | 1.46 | >99 | 12 |
| Example 5 | 1.138 | <0.010 | 1.50 | >99 | 10 |
| Comparative | 1.242 | <0 010 | 2.71 | >99 | 14 |
| Example 1 | | | | | |
| Comparative | 1.314 | <0.010 | 2.04 | 83 | 122 |
| Example 2 | | | | | |
| Comparative | 1.979 | <0.010 | >10 | 0.1 | 162 |
| Example 3 | | | | | |
| Comparative | 1.036 | <0.010 | 1.57 | >99 | 25 |
| Example 4 | | | | | |

After retaining a measuring sample at 60° C. for 72 hours, which is the same as the measuring sample used for measurement of the absorbance and the light transmittance in Examples 1 to 5, absorbance and light transmittance were measured in the same manner. The absorbance for light having a wavelength of 400 nm was 1.00 or more and less than 1.50, the absorbance for light having a wavelength of 290 nm was 1.000 or more, the absorbance for light having a wavelength of 450 to 600 nm was 0.010 or less, and the light transmittance for light having a wavelength of 500 nm was 50%/cm or more.

(Appearance Evaluation of Storage Liquid for Slurry)

Water was added to the slurry precursor 2, and the abrasive grain content was adjusted to 1.0 mass % to obtain a storage liquid 1 for a slurry. Moreover, apart from the storage liquid 1 for a slurry, a storage liquid 2 for a slurry was prepared by storing the storage liquid 1 for a slurry at 60° C. for 72 hours. Observation results of appearances of the storage liquids 1 and 2 for a slurry are shown in Table 3.

(pH Measurement of Storage Liquid for Slurry)

The pHs (25° C.) of the storage liquid 1 for a slurry and the storage liquid 2 for a slurry were measured using model number PH81 manufactured by Yokogawa Electric Corporation. The results are shown in Table 3.

(Preparation of Slurry)

150 g of pure water was added to 100 g of each of the storage liquids 1 and 2 for a slurry to obtain slurries 1 and 2 having an abrasive grain content of 0.4 mass %.

(Preparation of Polishing Liquid)

An additive liquid 1 comprising 5 mass % polyvinyl alcohol as an additive and X mass % imidazole was prepared. 150 g of water was added to 100 g of the additive liquid 1 to obtain an additive liquid 2. The slurry 1 and the additive liquid 2 were mixed at 1:1 (mass ratio) to obtain a polishing liquid 1 (abrasive grain content: 0.2 mass %, polyvinyl alcohol content: 1.0 mass %). The above-described X mass % was determined such that the pH of the polishing liquid is 6.0. It is to be noted that the saponification degree of polyvinyl alcohol in the polyvinyl alcohol aqueous solution was 80 mol % and the average degree of polymerization was 300.

In the same manner, the slurry 2 (slurry obtained from storage liquid for slurry, which had been stored at 60° C. for 72 hours) and the additive liquid 2 were mixed to obtain a polishing liquid 2.

(Polishing of Insulating Film)

A φ200 mm silicon wafer on which a silicon oxide film as an insulating film is formed was set in a holder, to which an adsorption pad for mounting a base substrate is attached, of the polishing device. The holder was placed on a platen to which a porous urethane resin pad is attached such that the insulating film was opposed to the pad. The base substrate was pressed against the pad at a polishing load of 20 kPa while supplying the polishing liquid obtained as above onto the pad at an amount supplied of 200 mL/min. At this time, polishing was performed for 1 minute by rotating the platen at 78 min⁻¹ and the holder at 98 min⁻¹. The wafer after polishing was washed with pure water well and dried. With respect to each of the polishing liquids 1 and 2, the polishing rate was determined by measuring a change in the film thickness before and after polishing, using a light-interference film thickness meter. Moreover, a ratio of the difference between the polishing rate of the polishing liquid 1 and the polishing rate of the polishing liquid 2 to the polishing rate of the polishing liquid 1 (difference between polishing rates/polishing rate of polishing liquid 1×100) was calculated as a polishing rate change ratio. The results are shown in Table 3.

TABLE 3

| | | | pH of Storage | | Polishing Rate | | Polishing |
|---|---|---|---|---|---|---|---|
| | | | Liquid for Slurry | | [nm/min] | | Rate |
| | Appearance Evaluation of Storage Liquid for Slurry | | Before | After | Before | After | Change |
| | Before Storing | After Storing | Storing | Storing | Storing | Storing | Ratio [%] |
| Example 1 | Slightly Turbid and Very Faint Yellow | Slightly Turbid and Very Faint Yellow | 3.4 | 3.1 | 265 | 255 | 3.8 |
| Example 2 | Transparent and Very Faint Yellow | Transparent and Very Faint Yellow | 3.4 | 3.1 | 281 | 267 | 5.0 |
| Example 3 | Transparent and Very Faint Yellow | Transparent and Very Faint Yellow | 3.5 | 3.2 | 277 | 264 | 4.7 |
| Example 4 | Transparent and Very Faint Yellow | Transparent and Very Faint Yellow | 3.6 | 3.3 | 270 | 259 | 4.1 |
| Example 5 | Transparent and Very Faint Yellow | Transparent and Very Faint Yellow | 3.5 | 3.2 | 278 | 267 | 4.0 |
| Comparative | Transparent and Faint Yellow | Transparent and Very Faint Yellow | 3.1 | 2.3 | 352 | 271 | 23.0 |
| Example 1 | | | | | | | |
| Comparative | Very Slightly Turbid and Faint Yellow | Very Slightly Turbid and Faint Yellow | 3.5 | 3.0 | 285 | 248 | 13.0 |
| Example 2 | | | | | | | |
| Comparative | Turbid and White | Turbid and White | 3.3 | 3.0 | 81 | 69 | 14.8 |
| Example 3 | | | | | | | |
| Comparative | Transparent and Faint Yellow | Transparent and Very Faint Yellow | 4.0 | 2.9 | 327 | 274 | 16.2 |
| Example 4 | | | | | | | |

As is clear from Table 3, the polishing liquids of Examples have clear appearances even after storing at 60° C. for 72 hours and small polishing rate change ratios.

1. A method for manufacturing an abrasive grain, comprising:
a step of obtaining a particle including a hydroxide of a tetravalent metal element by mixing a metal salt solution comprising a salt of the tetravalent metal element with an alkali liquid; and
a step of heating the particle including the hydroxide of the tetravalent metal element.

2. The method for manufacturing an abrasive grain according to claim 1, wherein the particle including the hydroxide of the tetravalent metal element is heated at 30° C. or more.

3. The method for manufacturing an abrasive grain according to claim 1, wherein the particle including the hydroxide of the tetravalent metal element is heated at 40° C. or more.

4. The method for manufacturing an abrasive grain according to claim 1, wherein the particle including the hydroxide of the tetravalent metal element is heated at 100° C. or less.

5. The method for manufacturing an abrasive grain according to claim 1, wherein the metal salt solution and the alkali liquid are mixed under a condition where a parameter Z represented by the following expression (1) is 5.00 or more:
Z=[1/(ΔpH×k)]×(N/M)/1000 (1)
wherein, in the expression (1), ΔpH represents a variation in pH per minute of a mixed liquid of the metal salt solution and the alkali liquid, k represents a reaction temperature coefficient, N represents a circulation count (min⁻¹), and M represents a replacement count (min⁻¹).

6. The method for manufacturing an abrasive grain according to claim 5, wherein the ΔpH is 1.000 or less.

7. The method for manufacturing an abrasive grain according to claim 5, wherein the circulation count N is represented by the following expression (2):
N=(u×S)/Q (2)
wherein, in the expression (2), u represents a linear speed (m/min) of a stirring blade for stirring the mixed liquid, S represents an area (m²) of the stirring blade, and Q represents a liquid amount (m³) of the mixed liquid.

8. The method for manufacturing an abrasive grain according to claim 7, wherein the linear speed u is 5.00 m/min or more in the following expression (3):
u=2π×R×r (3)
wherein, in the expression (3), R represents a rotational frequency (min⁻¹) of the stirring blade, and r represents a rotational radius (m) of the stirring blade.

9. The method for manufacturing an abrasive grain according to claim 8, wherein the rotational frequency R is 30 min⁻¹ or more.

10. The method for manufacturing an abrasive grain according to claim 5, wherein the circulation count N is 1.00 min⁻¹ or more.

11. The method for manufacturing an abrasive grain according to claim 5, wherein the replacement count M is represented by the following expression (4):
M=v/Q (4)
wherein, in the expression (4), v represents a mixing rate (m³/min) of the metal salt solution and the alkali liquid, and Q represents a liquid amount (m³) of the mixed liquid.

12. The method for manufacturing an abrasive grain according to claim 11, wherein the mixing rate v is 5.00×10⁻³ m³/min or less.

13. The method for manufacturing an abrasive grain according to claim 5, wherein the replacement count M is 1.0 min⁻¹ or less.

14. The method for manufacturing an abrasive grain according to claim 1, wherein a concentration of the salt of the tetravalent metal element in the metal salt solution is 0.010 mol/L or more.

15. The method for manufacturing an abrasive grain according to claim 1, wherein an alkali concentration in the alkali liquid is 15.0 mol/L or less.

16. The method for manufacturing an abrasive grain according to claim 1, wherein a pH of a mixed liquid of the metal salt solution and the alkali liquid is 1.5 to 7.0.

17. The method for manufacturing an abrasive grain according to claim 1, wherein the tetravalent metal element is tetravalent cerium.

18. A method for manufacturing a slurry, comprising:
a step of obtaining a slurry by mixing the abrasive grain obtained by the method for manufacturing an abrasive grain according to claim 1, and water.

19. A method for manufacturing a polishing liquid, comprising:
a step of obtaining a polishing liquid by mixing the slurry obtained by the method for manufacturing a slurry according to claim 18, and an additive.

20. A method for manufacturing a polishing liquid, comprising:
a step of obtaining a polishing liquid by mixing the abrasive grain obtained by the method for manufacturing an abrasive grain according to claim 1, an additive, and water.

21. An abrasive grain obtained by the method for manufacturing an abrasive grain according to claim 1.

22. A slurry obtained by the method for manufacturing a slurry according to claim 18.

23. A polishing liquid obtained by the method for manufacturing a polishing liquid according to claim 19.

24. A polishing liquid obtained by the method for manufacturing a polishing liquid according to claim 20.
